(19) United States
(12) Patent Application Publication
(10) Pub. No.: US 2025/0104693 A1
(43) Pub. Date: Mar. 27, 2025

(54) NATURAL LANGUAGE GENERATION

(71) Applicant: Amazon Technologies, Inc., Seattle, WA (US)

(72) Inventors: Constantinos Papayiannis, Berlin (DE); Roberto Barra Chicote, Cambridge (GB); Trevor Michael Wood, Ely (GB); James Garnet Droppo, Carnation, WA (US)

(21) Appl. No.: 18/474,484

(22) Filed: Sep. 26, 2023

(51) Int. Cl. G10L 13/10; G10L 13/047; G10L 25/18

(52) U.S. Cl. CPC G10L 13/10; G10L 13/047; G10L 25/18

(57) ABSTRACT

Techniques for using a language model (e.g., a large language model (LLM)) to generate a natural language response to a user input and prosody information (e.g., voice characteristics associated with a synthetic voice to output the natural language response to the user) are described. The prosody information may correspond to a natural language (e.g., text or tokenized) description, a spectrogram, and/or a latent representation of the voice characteristic(s) associated with the natural language response. In some embodiments, the natural language response and the prosody information may be generated by different portions of layers of the language model. In such embodiments, the output of the layer(s) of the language model configured to generate the natural language response may be provided to the layer(s) of the language model configured to generate the prosody information and the output may be used to generate the prosody information, and vice versa.

### BACKGROUND

A speech processing system may include a speech-synthesis component for processing input data such as text and/or audio to determine output data that includes a representation of speech. The speech corresponds to one or more characteristics, such as tone, pitch, or frequency. The speech-synthesis component processes different characteristics to produce different speech.

### BRIEF DESCRIPTION OF DRAWINGS

For a more complete understanding of the present disclosure, reference is now made to the following description taken in conjunction with the accompanying drawings.

FIG. 1 is a conceptual diagram illustrating example components and processing of a system configured to generate a natural language response to a user input and prosody information representing a voice characteristic(s) associated with a synthetic voice to be used to output the natural language response, according to embodiments of the present disclosure.

FIG. 2 is a conceptual diagram illustrating example processing of natural language layers and prosody layers of the natural language and prosody LLM, according to embodiments of the present disclosure.

FIG. 3 is a conceptual diagram of text-to-speech components, according to embodiments of the present disclosure.

FIG. 4 is a conceptual diagram illustrating further example components and processing of the system, which are configured to determine a response to a user input, according to embodiments of the present disclosure.

FIG. 5 is a conceptual diagram illustrating example components and processing of a plan generation component, according to embodiments of the present disclosure.

FIG. 6 is a conceptual diagram illustrating example components and processing of a LLM shortlister component, according to embodiments of the present disclosure.

FIG. 7 is a conceptual diagram illustrating example components and processing of a response arbitration component, according to embodiments of the present disclosure.

FIG. 8 is a conceptual diagram of components of the system, according to embodiments of the present disclosure.

FIG. 9 is a conceptual diagram illustrating example processing of an arbitrator component, according to embodiments of the present disclosure.

FIG. 10 is a block diagram conceptually illustrating example components of a device, according to embodiments of the present disclosure.

FIG. 11 is a block diagram conceptually illustrating example components of a system, according to embodiments of the present disclosure.

FIG. 12 illustrates an example of a computer network for use with the overall system, according to embodiments of the present disclosure.

### DETAILED DESCRIPTION

Automatic speech recognition (ASR) is a field of computer science, artificial intelligence, and linguistics concerned with transforming audio data associated with speech into a token or other textual representation of that speech. Similarly, natural language understanding (NLU) is a field of computer science, artificial intelligence, and linguistics concerned with enabling computers to derive meaning from natural language inputs (such as spoken inputs). ASR and NLU are often used together as part of a language processing component of a system. Text-to-speech (TTS) is a field of computer science concerning transforming textual and/or other data into audio data that is synthesized to resemble human speech. Natural language generation (NLG) is a field of artificial intelligence concerned with automatically transforming data into natural language (e.g., English) content. Language modeling (LM) is the use of various statistical and probabilistic techniques to determine the probability of a given sequence of words occurring in a sentence. LM can be used to perform various tasks including understanding a natural language input (e.g., when noise is present) and performing generative tasks that involve generating natural language output data.

Certain systems may be configured to respond to natural language (e.g., spoken or typed) user inputs. For example, in response to the user input “what is today's weather,” the system may output weather information for the user's geographic location. As another example, in response to the user input “what are today's top stories,” the system may output one or more news stories. For further example, in response to the user input “tell me a joke,” the system may output a joke to the user.

A system may receive a user input as speech. For example, a user may speak an input to a device. The device may send audio data, representing the spoken input, to the system. The system may perform ASR processing on the audio data to generate ASR data (e.g., text data, token data, etc.) representing the user input. The system may perform processing on the ASR data to determine an action responsive to the user input.

In some instances, the system may be configured to process the ASR data or other input text data using one or more language models (e.g., one or more large language models (LLMs)) to generate a natural language response to the user input and prosody information corresponding to one or more voice characteristics associated with the natural language response. For example, in response to a user input of “what is the origin of Halloween,” the language model(s) may output a natural language response describing the origin of Halloween and prosody information representing that the natural language response is to be output to the user using an ominous, spooky-sounding voice. For further example, in response to a user input of “tell me a story about [story topic],” the language model(s) may output a natural language response corresponding to the requested story and prosody information corresponding to a narrating voice that the user has previously indicated they prefer for story-telling. As another example, in response to a user input of “what do kangaroos eat,” the language model(s) may output a natural language response describing the diet of kangaroos and prosody information representing that the natural language response is to be output to the user in the voice of a wildlife documentary narrator. As an even further example, in response to a user input of “What are people saying about [Movie name],” the language model(s) may output a natural language response summarizing reviews of the movie and prosody information representing that the natural language response is to be output to the user in the voice of a movie critic.

The present disclosure describes techniques for using LLM(s) to generate a natural language response to a user input and prosody information corresponding to one or more voice characteristics associated with the natural language response. The LLM(s) receive a prompt including a user input, contextual information (e.g., weather information, time of day, device information associated with the device that captured the user input (e.g., device ID, device states, historical device interaction data, etc.), information associated with a user that provided the user input (e.g., information associated with a user profile of the user (e.g., user ID, user behavioral information, user preferences such as voice characteristics/synthetic voices preferred by the user and/or example scenarios where a user has preferred particular voice characteristics/synthetic voices (e.g., as indicated by the user and/or determined by the system), age, gender, historical user interaction data, devices associated with the user profile, dialog history data representing one or more user inputs and corresponding system-generated responses for a current interaction between the user and the system 100, etc.)), and, optionally, information potentially responsive to the user input (e.g., which may be determined/generated by another component of the system in response to the user input, such as search-query results). The LLM(s) use the prompt to generate a natural language response to the user input and prosody information corresponding to a voice characteristic(s) associated with a synthetic voice to be used to output the natural language response to the user.

The LLM(s) may be configured to generate various representations of prosody information corresponding to the response to the user input. For example, the prosody information may be a natural language description of the voice characteristic(s). For example, in response to a user input of “tell me an uplifting story,” the LLM(s) may output prosody information corresponding to “upliftingly” “happily,” or the like consistent with how “uplifting” is conveyed in the relevant culture/geography. For further example, in response to a user input of “tell me a story about a home-sick Cowboy,” the LLM(s) may output prosody information correspond to “spoken like a Cowboy staring off into the distance longingly,” or the like as portrayed in movies of the relevant culture/geography. In some embodiments, the prosody information may be a tokenized description of the voice characteristic(s). For example, in response to a user input of “what is the origin of Halloween,” the LLM(s) may output prosody information corresponding to a label (e.g., a tag (e.g., a mark-up language tag, such as a Speech Synthesis Markup Language (SSML) tag), an indicator, etc.) and/or an emoji of a jack-o-lantern, a bat, a vampire, a scared face, or the like. For further example, in response to an ambiguous user input that requires further input for the system to generate a response, the LLM(s) may output prosody information corresponding to an emoji of an inquisitive-looking face, a label of “inquisitive,” or the like. In some embodiments, the prosody information may represent a voice characteristic(s) associated with one or more portions (e.g., words, tokens, etc.) of a response to the user input. For example, in response to a user input of “tell me a joke,” the LLM(s) may output prosody information including a first portion associated with a setup of the joke and a second portion associated with a punchline of the joke. For further example, in response to a user input of “tell me today's top stories,” the LLM(s) may output prosody information including a first portion associated with a portion of the response corresponding to a tragic story and a second portion associated with a portion of the response corresponding to an uplifting story. In some embodiments, the model output prosody data may be a spectrogram representing synthesized speech including the voice characteristic(s). In some embodiments, the model output prosody data may be a latent representation of the voice characteristic(s), an acoustic representation of the voice characteristic(s), and/or some other representation of the voice characteristic(s) that is usable to generate corresponding audio data (e.g., a vector of continuous/quantized values).

In some embodiments, the natural language response and the prosody information may be generated by different portions (e.g., layers) of the LLM, which are configured to communicate during their respective processing in order to generate the natural language response and the prosody information. For example, the output of a natural language generation layer(s) may be sent to a prosody prediction layer(s) of the LLM. The prosody prediction layer(s) may use the output to generate the corresponding prosody information. For further example, in some embodiments, the output of the prosody prediction layer(s) may be sent to the natural language generation layer(s) to generate the corresponding natural language response. In other embodiments, the LLM may include layer(s) configured to generate both of the natural language response and the prosody information.

Teachings of the present disclosure provide, among other things, improved computer processing by providing a system capable of using LLM(s) to generate a natural language response to a user and prosody information corresponding to the natural language response. This can result in improved computer processing by allowing components of the system to utilize the context-aware processing capabilities of the LLM(s) to generate the prosody information corresponding to the natural language response. As such, a downstream component tasked with generating audio corresponding to the natural language response (e.g., a TTS component) may use the prosody information generated by the LLM(s) (which was generated based on the contextual information included in the prompt provided to the LLM(s)) to generate the corresponding audio, rather than repeating processing with respect to the contextual information to generate the corresponding prosody information. Further, in some embodiments, the LLM(s) may be better equipped to understand the complex relationships between the contextual information and the user input. This can result in improved computer processing by generating audio spoken by a synthetic voice including voice characteristics that are more contextually relevant to the user input and, therefore, more likely to result in the user being satisfied with the output audio.

A system according to the present disclosure will ordinarily be configured to incorporate user permissions and only perform activities disclosed herein if approved by a user. As such, the systems, devices, components, and techniques described herein would be typically configured to restrict processing where appropriate and only process user data in a manner that ensures compliance with all appropriate laws, regulations, standards, and the like. The system and techniques can be implemented on a geographic basis to ensure compliance with laws in various jurisdictions and entities in which the components of the system and/or user are located.

Language modeling (LM) is the use of various statistical and probabilistic techniques to determine the probability of a given sequence of words occurring in a sentence. Language models analyze bodies of text data to provide a basis for their word predictions. The language models are generative models. In some embodiments, the language models may be a LLM. An LLM is an advanced artificial intelligence system designed to process, understand, and generate human-like text based on massive amounts of data. In some embodiments, an LLM may be further designed to process, understand, and generate multi-modal data including audio, text, image, and/or video. An LLM model may be built using deep learning techniques, such as neural networks, and may be trained on extensive datasets that include text (or other type of data, such as multi-modal data including text, audio, image, video, etc.) from a broad range of sources, such as books and websites, for natural language processing. An LLM uses an expansive training dataset, as compared to a language model, and can include a large number of parameters (in the range of billions), hence, they are called “large” language models. In some embodiments one or more of the language models (and their corresponding operations, discussed herein below) may be the same language model.

In some embodiments where one or more of the language models are LLMs, the one or more language model may be transformer-based seq2seq models involving an encoder-decoder architecture. In an encoder-decoder architecture, the encoder may produce a representation of an input (e.g., audio, text, image, video, etc.) using a bidirectional encoding, and the decoder may use that representation to perform some task. In some such embodiments, one or more of the language models may be a multilingual (approximately) 20 billion parameter seq2seq model that is pre-trained on a combination of denoising and Causal Language Model (CLM) tasks in various languages (e.g., English, French, German, Arabic, Hindi, Italian, Japanese, Spanish, etc.), and the language model may be pre-trained for approximately 1 trillion tokens. Being trained on CLM tasks, the one or more language models may be capable of in-context learning. An example of such a LLM is Alexa Teacher Model (Alexa™).

In other embodiments, where one or more of the language models are an LLM, the one or more language models may be a decoder-only architecture. The decoder-only architecture may use left-to-right (unidirectional) encoding of the input (e.g., audio, text, image, video, etc.). An example of such a LLM is the Generative Pre-trained Transformer 3 (GPT-3) and other versions of GPT. GPT-3 has a capacity of (approximately) 175 billion machine learning parameters.

Other examples of LLMs include Big Science Large Open-science Open-access Multilingual Language Model (BLOOM), Language Model for Dialogue Applications model (LaMDA), Bard, Large Language Model Meta AI (LLaMA), Titan Foundational Model, etc.

In some embodiments, the system may include one or more machine learning model(s) other than one or more of the language models. Such machine learning model(s) may receive text and/or other types of data as inputs (e.g., audio, image, video, etc.), and may output text and/or the other types of data. Such model(s) may be neural network-based models, deep learning models, classifier models, autoregressive models, seq2seq models, etc.

In embodiments where one or more of the language models are an LLM, the input to the LLM may be in the form of a prompt. A prompt may be a natural language input, for example, an instruction, for the LLM to generate an output according to the prompt. The output generated by the LLM may be a natural language output responsive to the prompt. In some embodiments, the output may be another type of data, such as audio, image, video, etc. The prompt and the output may be text in a particular language (e.g., English, Spanish, German, etc.) and/or other types of data such as audio, image, video, etc. For example, for an example prompt “how do I cook rice?”, the LLM may output a recipe (e.g., a step-by-step process represented by text, audio, image, video, etc.) to cook rice. As another example, for an example prompt “I am hungry. What restaurants in the area are open?”, the LLM may output a list of restaurants near the user 405 that are open at the time.

The language models may be configured using various learning techniques. For example, in some embodiments, the language models may be configured using few-shot learning. In few-shot learning, the model learns how to learn to solve the given problem. In this approach, the model is provided with a limited number of examples (i.e., “few shots”) from the new task, and the model uses this information to adapt and perform well on that task. Few-shot learning may require fewer amount of training data than implementing other fine-tuning techniques. For further example, in some embodiments, the language models may be configured using one-shot learning, which is similar to few-shot learning, except the model is provided with a single example. As another example, in some embodiments, the language models may be configured using zero-shot learning. In zero-shot learning, the model solves the given problem without examples of how to solve the specific/similar problem and just based on the model's training dataset. In this approach, the model is provided with data sampled from a class not observed during training, and the model learns to classify the data.

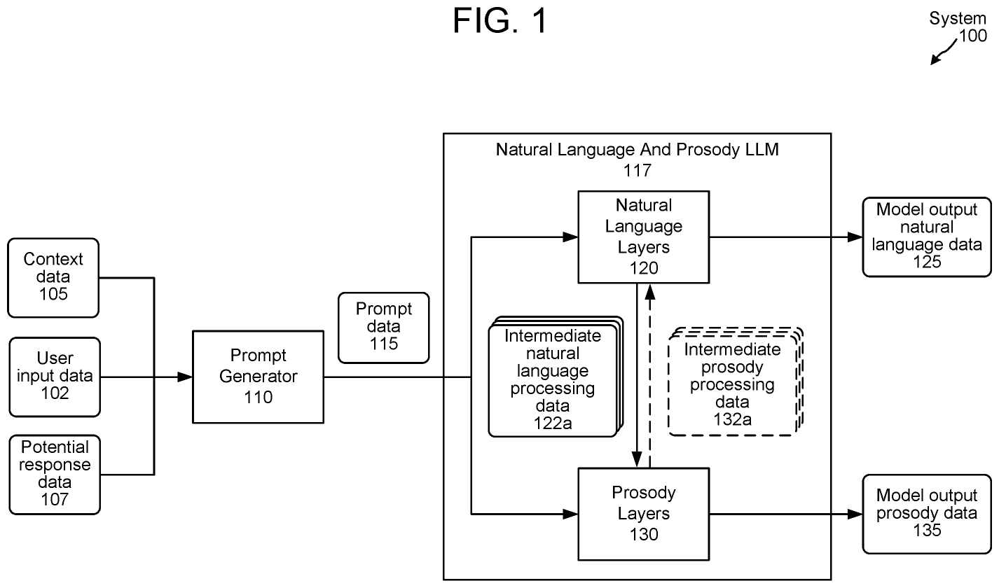

FIG. 1 illustrates example processing and components of the system 100 to generate a natural language response to a user input and prosody information representing voice characteristics associated with a synthetic voice to speak the natural language response. As shown in FIG. 1 the system 100 may include a prompt generation component 110 and a natural language and prosody LLM 117, which may include natural language layers 120 and prosody layers 130.

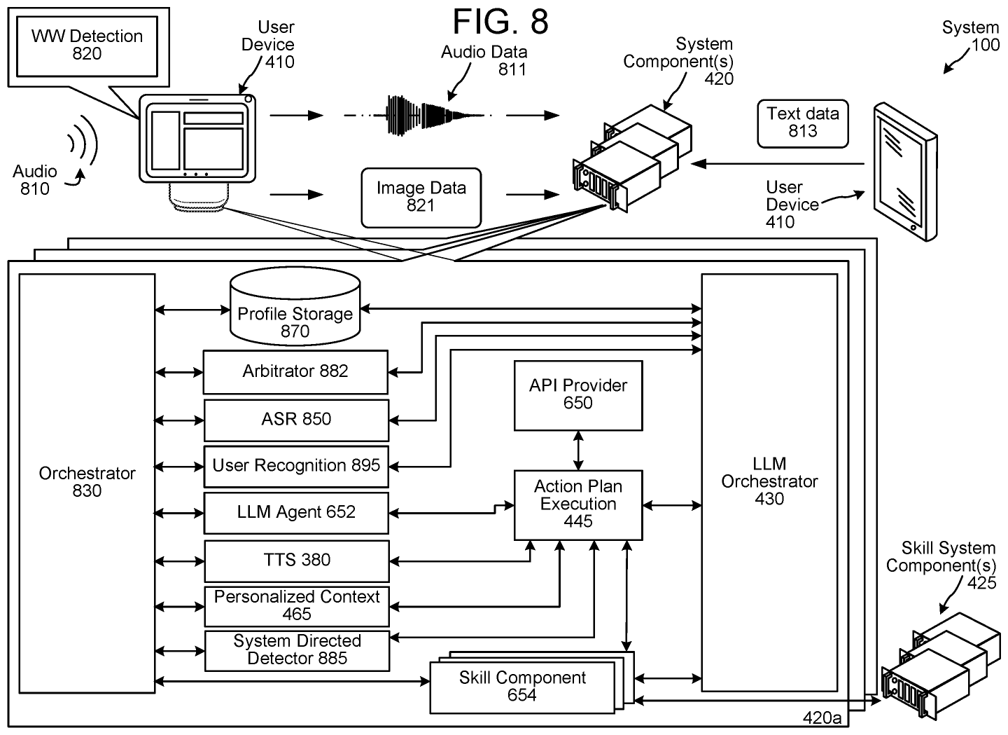

In some embodiments, the prompt generation component 110 may generate prompt data representing a prompt for input to the natural language and prosody LLM 117. As shown in FIG. 1, the prompt generation component 110 receives user input data 102. In some instances, the user input data 102 may correspond to various data types, such as text (e.g., a text or tokenized representation of a user input), audio, image, video, etc. For example, the user input data may include input text (or tokenized) data when the user input is a typed natural language user input. For further example, prior to the prompt generation component 110 receiving the user input data 102, another component (e.g., an automatic speech recognition (ASR) component 850) of the system 100 may receive audio data representing the user input. The ASR component 850 may perform ASR processing on the audio data to determine ASR data corresponding to the user input, which may correspond to a transcript of the user input. As described below, with respect to FIG. 8, the ASR component 850 may determine ASR data that includes an ASR N-best list including multiple ASR hypotheses and corresponding confidence scores representing what the user may have said. The ASR hypotheses may include text data, token data, ASR confidence score, etc. as representing the input utterance. The confidence score of each ASR hypothesis may indicate the ASR component's 850 level of confidence that the corresponding hypothesis represents what the user said. The ASR component 850 may also determine token scores corresponding to each token/word of the ASR hypothesis, where the token score indicates the ASR component's 850 level of confidence that the respective token/word was spoken by the user. The token scores may be identified as an entity score when the corresponding token relates to an entity. In some instances, the user input data 102 may include a top scoring ASR hypothesis of the ASR data. As an even further example, in some embodiments, the user input may correspond to an actuation of a physical button, data representing selection of a button displayed on a graphical user interface (GUI), image data of a gesture user input, combination of different types of user inputs (e.g., gesture and button actuation), etc. In such embodiments, the system 100 may include one or more components configured to process such user inputs to generate the text or tokenized representation of the user input (e.g., the user input data 102).

As further shown in FIG. 1, in some embodiments, the prompt generation component 110 may further receive context data 105. The context data 105 may represent various contextual information associated with the user input data 102, such as weather information, time of day, device information associated with the device that sent the user input data 102 (e.g., device ID, device states, historical device interaction data, etc.), information associated with a user that provided the user input (e.g., information associated with a user profile of the user (e.g., user ID, user behavioral information, user preferences such as voice characteristics/synthetic voices preferred by the user and/or example scenarios where a user has preferred particular voice characteristics/synthetic voices (e.g., as indicated by the user and/or determined by the system 100), age, gender, historical user interaction data, devices associated with the user profile, dialog history data representing one or more user inputs and corresponding system-generated responses for a current interaction between the user and the system 100, etc.), which may be determined using, for example, a user recognition component 895). In some embodiments, an indication of the user and/or user profile may be included in the user input data 102 (e.g., as included in the output of the ASR component 850 or other components).

As used herein, a “dialog” may refer to multiple related user inputs and system 100 outputs (e.g., through user device(s) 410) between the system and the user that may have originated with a single user input initiating the dialog. Thus, the data associated with a dialog may be associated with a same dialog identifier, which may be used by components of the overall system 100 to associate information across the dialog. Subsequent user inputs of the same dialog may or may not start with the user speaking a wakeword. Each natural language input may be associated with a different natural language input identifier, and each natural language input identifier may be associated with a corresponding dialog identifier. Further, other non-natural language inputs (e.g., image data, gestures, button presses, etc.) may relate to a particular dialog depending on the context of the inputs. For example, a user may open a dialog with the system 100 to request a food delivery in a spoken utterance and the system may respond by displaying images of food available for order and the user may speak a response (e.g., “item 1” or “that one”) or may gesture a response (e.g., point to an item on the screen or give a thumbs-up) or may touch the screen on the desired item to be selected. Non-speech inputs (e.g., gestures, screen touches, etc.) may be part of the dialog and the data associated therewith may be associated with the dialog identifier of the dialog.

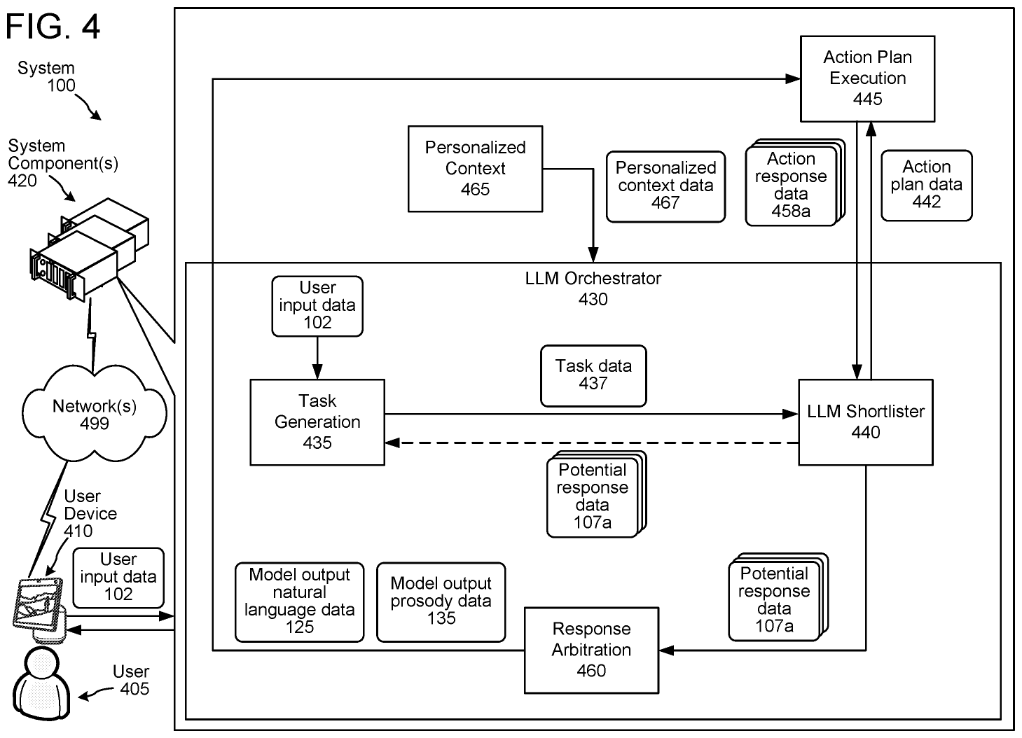

In some embodiments, the prompt generation component 110 may further receive potential response data 107. For example, as will be discussed in detail herein below with respect to FIG. 4, if the current iteration of processing with respect to the user input data 102 is a subsequent iteration of processing (e.g., the system 100 previously caused one or more components to generate information potentially responsive to the user input data 102 (e.g., search-query results), then the prompt generation component 110 may further receive the potential response data 107. In such embodiments, the prompt data 115 may be generated based on combining the user input data 102, the context data 105, and the potential response data 107.

In some embodiments, the prompt data 115 may be an instruction for the natural language and prosody LLM 117 to generate a natural language response to the user input given the information (e.g., user input data 102 and, optionally, the context data 105 and/or the potential response data 107) included in the prompt data 115. Optionally, the prompt data 115 may further be an instruction for the natural language and prosody LLM 117 to generate prosody information corresponding to the natural language response. In some embodiments, the prompt generation component 110 may also include in the prompt data 115 a sample processing format to be used by the natural language and prosody LLM 117 when processing the prompt data 115. In some embodiments, the prompt generation component 110 may generate the prompt data 115 according to a template format, such as:

{
You are a conversational AI agent that communicates with users to
satisfy their request. If no response is needed, indicate that.
Here is the user's request:
[user input data 102]
Here is the context and/or the potential responses:
[context data 105]
[potential response data 107]
}

Following such a template format, for example, and for an example user input of “Tell me a scary story,” the prompt generation component 110 may generate example prompt data 115a:

```
{
You are a conversational AI agent that communicates with users to
satisfy their request. If no response is needed, indicate that.
Here is the user's request:
Tell me a scary story
Here is the context:
Dialog history:
  Who is Dracula based on?
User behavior:
  User has recently purchased books about vampires
}
```

For further example, for a second example user input of “How fast can they move,” the task selection prompt generation component 530 may generate example prompt data 115b:

{
You are a conversational AI agent that communicates with users to
satisfy their request. If no response is needed, indicate that.
Here is the user's request:
How fast can they move?
Here is the context:
Dialog history:
How big do kangaroos get?
}

In some embodiments, the prompt generation component 110 may also include in the prompt data an instruction to output a response that satisfies certain conditions. Such conditions may relate to generating a response that is unbiased (toward protected classes, such as gender, race, age, etc.), non-harmful, profanity-free, etc. For example, the prompt data may include “Please generate a polite, respectful, and safe response and one that does not violate protected class policy.”

The prompt data 115 is received at the natural language layers 120 and the prosody layers 130 of the natural language and prosody LLM 117. The natural language layers 120 process the prompt data 115 to generate model output natural language data 125 corresponding to a textual (or tokenized) response to the user input data 102. For example, based on processing the first example prompt data 115a provided above, the natural language layers 120 may output model output natural language data 125a corresponding to a scary story about vampires, starring Dracula (e.g., {“There once was a vampire named Dracula, who was the most feared of all vampires . . . ,” } or the like). For further example, based on processing the first example prompt data 115a provided above, the natural language layers 120 may output model output natural language data 125b corresponding to “Kangaroos can reach speeds of up to 30 miles per hour,” or the like. In some embodiments, the model output natural language data 125 may be generated using the context data 105, for example, the natural language layers 120 may output the model output natural language data 125a discussed above in response to the context data 105 representing that the user has previously asked about Dracula and has recently purchased books about vampires. For further example, the natural language layers 120 may output the model output natural language data 125b discussed above in response to the context data 105 representing that the user's previous question was regarding kangaroos.

The prosody layers 130 process the prompt data 115 to generate model output prosody data 135 representing a voice characteristic(s) corresponding to a synthetic voice associated with a response to the user input data 102 (e.g., associated with the model output natural language data 125). As discussed above, in some embodiments, the model output prosody data 135 may be a natural language description of the voice characteristic(s). For example, based on processing the first example prompt data 115a provided above, the prosody layers 130 may output model output prosody data 135a: {“scary,” “tensely,” “terrifyingly,” “fearfully” “spoken in a spooky, hushed tone,” “spoken like a scary story told around a campfire at night” }, and/or the like. For further example, based on processing the second example prompt data 115b provided above, the prosody layers 130 may output model output prosody data 135b: {“in awe,” “spoken as a matter of fact,” “spoken like a wildlife documentary narrator,” } and/or the like. In some embodiments, the model output prosody data 135 may be a tokenized description of the voice characteristic(s). For example, based on processing the first example prompt data 115a provided above, the prosody layers 130 may output model output prosody data 135a including a tokenized representation of scary, fearful, spooky, and/or the like (e.g., labels associated with scary, fearful, spooky, and/or the like, and/or emojis, such as a scared face, a jack-o-lantern, etc.). For further example, based on processing the second example prompt data 115b provided above, the prosody layers 130 may output model output prosody data 135b including a tokenized representation of nature, animals, facts, awe, and/or the like (e.g., labels associated with nature, animals, facts, awe, and/or the like, and/or emojis, such as a smart-looking emoji, an animal, flora/fauna, a face of amazement, etc.). In some embodiments, the model output prosody data 135 may be a spectrogram representing synthesized speech spoken by a voice including the voice characteristic(s). For example, based on processing the first example prompt data 115a provided above, the prosody layers 130 may output model output prosody data 135a including a spectrogram representing synthesized speech spoken by a voice including voice characteristics associated with telling a scary story. For further example, based on processing the second example prompt data 115b provided above, the prosody layers 130 may output model output prosody data 135b including a spectrogram representing synthetic speech spoken by a voice including voice characteristics associated with a wildlife documentary narrator. In some embodiments, the model output prosody data 135a may be a latent representation of the voice characteristic(s), an acoustic representation of the voice characteristic(s), and/or some other proxy representation of the voice characteristic(s) (e.g., a vector of continuous/quantized values) that is understandable by a downstream component of the system 100 (e.g., the TTS component 380).

In some embodiments, the model output prosody data 135 may include a fixed-length vector representing a voice characteristic(s) associated with one or more words/tokens of a response to the user input data 102 (e.g., associated with the model output natural language data 125). As such, the prosody layers 130 may be configured to output various prosody information that is tailored to one or more portions of the corresponding response to the user input (e.g., generate prosody information for a joke that includes first prosody information for a first portion of the joke that corresponds to a set up and second prosody information for a second portion of the joke that corresponds to the punchline, generate prosody information that coincides with a newscaster conveying multiple news stories with varying emotion (e.g., first prosody information associated with a tragic story and second prosody information for a subsequent uplifting story)). For example, based on processing the first example prompt data 115a provided above, the prosody layers 130 may output model output prosody data 135a representing (1) a first voice characteristic(s) associated with one or more words of a beginning of the response (e.g., the scary story) correspond to “ominous,” “spoken in a dark, soft spoken tone,” a corresponding tokenized representation (e.g., a label corresponding to “ominous,” “spoken in a dark, soft spoken tone” and/or an emoji of a moon, bats, a jack-o-lantern, a ghost, etc.), a spectrogram representing synthetic speech spoken by a voice including the first voice characteristics, or the like; and (2) a second voice characteristic(s) associated with one or more words corresponding to the climax of the response correspond to “loud,” “terrifying,” “spoken intensely,” “spoken like the climax of a scary story,” a corresponding tokenized representation (e.g., a label corresponding to “loud,” “terrifying,” “spoken intensely,” “spoken like the climax of a scary story,” and/or an emoji of a scared face, a vampire, etc.), a spectrogram representing synthetic speech spoken by a voice including the second voice characteristics, or the like.

As discussed above, the prompt data 115 may include the context data 105, which may be used by the prosody layers 130 to generate the model output prosody data 135. This may allow the prosody layers 130 to generate the model output prosody data 135 to correspond voice characteristics that are based on context data 105 (e.g., based on environmental signals (e.g., weather, time, etc.), based on user behaviors/preferences such as voice characteristics/synthetic voices preferred by the user and/or example scenarios where the user has preferred particular voice characteristics/synthetic voices (e.g., as indicated by the user and/or determined by the system 100), based on previous interactions with the user, etc.). For example, the model output prosody data 135a may further include {“spoken like Dracula,” }, a tokenized representation of a vampire (e.g., a label corresponding to “spoken like Dracula,” and/or a vampire emoji), a spectrogram representing synthetic speech spoken by a voice including voice characteristics associated with a Dracula-sounding voice, or the like, based on the context data 105 indicating that the user is potentially interested in vampires and Dracula.

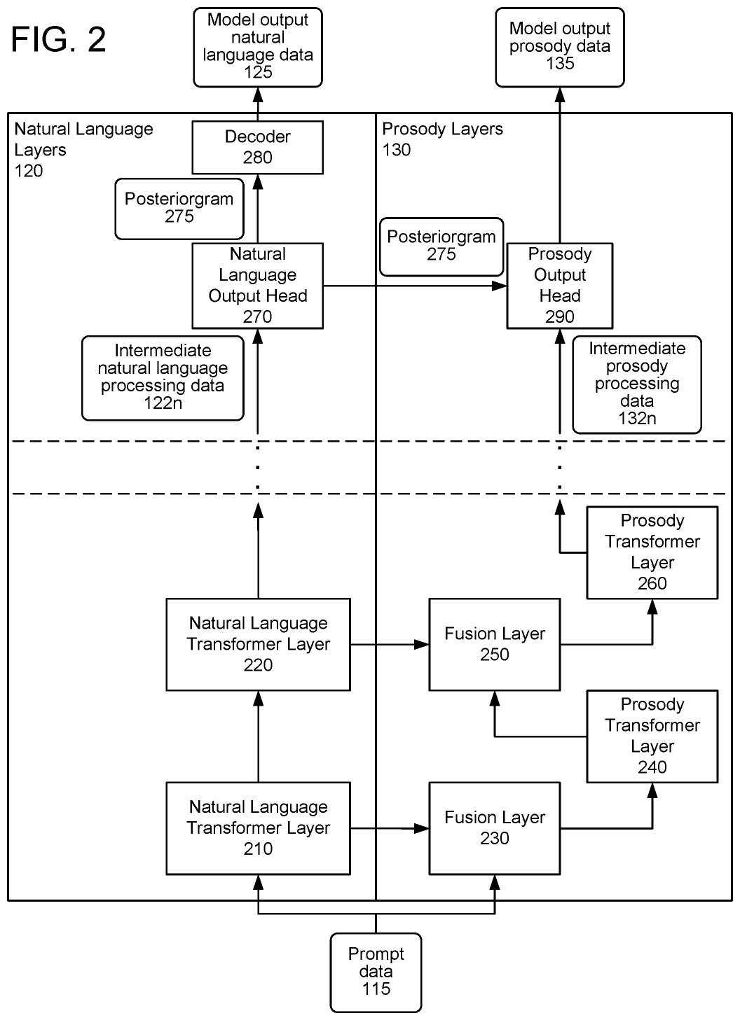

As shown in FIG. 1, the natural language layers 120 and the prosody layers 130 of the natural language and prosody LLM 117 may be at least partially in communication. As is discussed in detail herein below with respect to FIG. 2, the prosody layers 130 may receive the output one or more layers (e.g., a hidden layer(s)) of the natural language layers 120). As such, the prosody layers 130 may process the output of the layer(s) of the natural language layers 120 to inform the decision(s) at one or more layers of the prosody layers 130 (e.g., to generate the model output prosody data 135). As discussed herein above, in some embodiments, configuring the natural language and prosody LLM 117 to allow for such communication allows the prosody layers 130 to benefit from the context-aware processing (e.g., encoding) capabilities of the natural language layers 120, which may result from the extensive training of the natural language layers 120 for the task of natural language generation and which may not (at least potentially not to the extent of that of the natural language layers 120) result from the training of the prosody layers 130 for the task of prosody prediction. In some embodiments, this may result in the prosody layers 130 being of a smaller dimension (and, potentially, requiring less training) than the natural language layers 120 while still being able to accurately generate prosody information associated with the natural language response to the user input generated by the natural language layers 120 (e.g., based on having access to the output of the layer(s) of the natural language layers 120 to inform the decision(s) at the one or more layers of the prosody layers 130).

In particular, as shown in FIG. 1, the prosody layers 130 may receive intermediate natural language processing data 122a-n from the layer(s) of the natural language layers 120. As is discussed in more detail herein below with respect to FIG. 2, the intermediate natural language processing data 122a-n may correspond to an embedded representation of the prompt data 115 (e.g., a continuous, fixed-length vector representation of the prompt data 115). As is discussed in more detail herein below with respect to FIG. 2, the intermediate natural language processing data 122a-n may further include attention information, indicating one or more contextual relationships between one or more portions (e.g., representing one or more words) of the prompt data 115. In other words, the attention information may indicate one or more portions of the intermediate natural language processing data 122a-n (e.g., representing the one or more words) that should be focused on during processing. For example, with respect to the prompt data 115a discussed herein above, the corresponding intermediate natural language processing data 122a resulting from processing of the prompt data 115a by the natural language layers 120 may indicate that the user's previous user input regarding Dracula and/or the user's recent purchase of vampire books are relevant to the user's request to tell a scary story (e.g., the word(s) “vampire” and/or “Dracula” is/are contextually associated with the word(s) scary and/or story (e.g., the natural language layers 120 should focus on the relationship between the words to generate the natural language user input responsive to the user input).

The prosody layers 130 may use the intermediate natural language processing data 122a-n to generate the model output prosody data 135 (e.g., to determine that the prosody information should correspond to voice characteristics associated with Dracula, vampires, and/or scary stories). In some embodiments, for example, the prosody layers 130 (e.g., the layer(s) of the prosody layers 130) may use the intermediate natural language processing data 122a-n to perform cross-attention (e.g., to process two different embeddings (e.g., the intermediate natural language processing data 122a-n and an embedding generated by the prosody layers 130) of the same dimensions to determine a contextual relationship(s) between one or more portions of the embeddings) with respect to the processing of the natural language layers 120 to generate the model output prosody data 135.

In some embodiments, the natural language layers 120 and the prosody layers 130 may process at least partially concurrently/in parallel. As such, the prosody layers 130 may receive the intermediate natural language processing data 122a-n from the natural language layers 120 as the intermediate natural language processing data 122a-n is output by the layer(s) of the natural language layers 120.

Additionally, or alternatively, in some embodiments, the natural language layers 120 may have access to the layer(s) of the prosody layers 130, such that the natural language layers 120 may process the output of the layer(s) of the prosody layers 130 to inform the decision at the corresponding layer(s) of the natural language layers 120. For example, as shown in FIG. 1, the prosody layers 130 may send intermediate prosody processing data 132a-n to the natural language layers 120, which may process as described herein above to inform the processing of the natural language layers 120 to generate the model output natural language data 125.

As discussed herein above, in some embodiments, the natural language and prosody LLM 117 may include a single set of layers configured to generate both of the model output natural language data 125 and the model output prosody data 135. In such embodiments, the prompt data 115 may be input to the layers, which may process as described herein above to generate model output including the natural language response to the user input and the corresponding prosody information.

FIG. 2 illustrates an example architecture of the natural language and prosody LLM 117 including the natural language layers 120 and the prosody layers 130, including example processing. As shown in FIG. 2, the natural language layers 120 may include multiple natural language transformer layers, such as the natural language transformer layer 210 and the natural language transformer layer 220. The natural language layers 120 may further include a natural language output head 270 and a decoder 280. The prosody layers 130 may include multiple fusion layers, such as the fusion layer 230 and the fusion layer 250. In some embodiments, the prosody layers 130 may include a corresponding fusion layer for a natural language transformer layer included in the natural language layers 120. The prosody layers 130 may further include multiple prosody transformer layers, such as the prosody transformer layer 240 and the prosody transformer layer 260. The prosody layers 130 may further include a prosody output head 290.

As shown in FIG. 2, the prompt data 715 is input to a first natural language transformer layer (e.g., the natural language transformer layer 210). The natural language transformer layer 210 is configured to generate an embedded representation of the prompt data 115 (e.g., intermediate natural language processing data 122a). The intermediate natural language processing data 122a may be a fixed-sized vector corresponding to a embedding of the prompt data 115 that further includes attention information (e.g., an indication of the attention to be given to portions of the intermediate natural language processing data 122a, which may be used by the decoder 280 to determine which portion(s) of the representation (e.g., which words of the prompt data 115) to focus on to generate the model output natural language data 125).

The intermediate natural language processing data 122a is sent to a second natural language transformer layer (e.g., the natural language transformer layer 220), which is configured to process the intermediate natural language processing data 122a to generate a further embedded representation of the prompt data 115 (e.g., intermediate natural language processing data 122b) including further attention information. The further attention information may represent further contextual relationships between the one or more words/tokens included in the prompt data 115, which may not have been represented in the intermediate natural language processing data 122a. For example, the intermediate natural language processing data 122a may represent a contextual relationship between (the representations of) the words “scary” and “story” (e.g., included in the user input data 102) including in the prompt data 115 and the intermediate natural language processing data 122a may further represent a contextual relationship between (the representations of) between the words “Dracula” and “vampires” and the words “scary” and “story.”

The output of the natural language transformer layer 220 is sent to a first fusion layer of the prosody layers 130 (e.g., the fusion layer 230). The fusion layer 230 may further receive the prompt data 115. The fusion layer 230 is configured to generate a fused embedded representation of the intermediate natural language processing data 122a and (an embedded representation of) the prompt data 115. In some embodiments, the fusion layer 230 may be a feed forward layer configured to apply one or more weights (determined as a result of training the prosody layers 130 for the prosody prediction task) to generate the fused embedded representation. As discussed herein above, this fused embedded representation may be used to inform the processing of the downstream layers of the prosody layers 130. The fusion layer 230 may send the fused embedded representation to a first prosody transformer layer (e.g., the prosody transformer layer 240), which may be configured to process similarly to the natural language transformer layers to generate intermediate prosody processing data 132a.

The intermediate prosody processing data 132a may be sent to a second fusion layer (e.g., the fusion layer 250), which may further receive the intermediate natural language processing data 122b generated by the natural language transformer layer 220. The fusion layer 250 may process as described herein above with respect to the fusion layer 230 to generate a fused embedded representation of the intermediate prosody processing data 132a and the intermediate natural language processing data 122b, which may be sent to a second prosody transformer layer (e.g., the prosody transformer layer 260) to generate intermediate prosody processing data 132b.

As discussed herein above, the natural language layers 120 may include multiple natural language transformer layers and the prosody layers 130 may include multiple fusion layers and prosody transformer layers, which may process as described above. In some embodiments, the prosody layers 130 may include the same number (e.g., n) of fusion layers and prosody transformer layers, respectively, as the natural language layers 120 has natural language transformer layers. For example, an nth natural language transformer layer may receive intermediate natural language processing data 122n−1 from a previous (e.g., nth−1) transformer layer of the natural language layers 120. The nth transformer layer may process the intermediate natural language processing data 122n−1 to generate intermediate natural language processing data 122n. Similar to the natural language transformer layer 210 and the natural language transformer layer 220, the intermediate natural language processing data 122n may be sent to a corresponding nth fusion layer of the prosody layers 130. The nth fusion layer may further receive intermediate prosody processing data 132n−1 from a previous (e.g., nth−1) prosody natural language transformer layer of the prosody layers 130. The nth fusion layer may fuse the intermediate natural language processing data 122n and the intermediate prosody processing data 132n−1 and send the fused embedded representation to an nth prosody natural language transformer layer to generate intermediate prosody processing data 132n.

The intermediate natural language processing data 122n may also be sent to a natural language output head 270. In some embodiments, the natural language output head 270 may be a feed forward layer. The natural language output head 270 processes the intermediate natural language processing data 122n to generate a posteriorgram 275 representing a result of applying one or more weights (determined as a result of training the natural language output head 270 for the natural language generation task) to the intermediate natural language processing data 122n.

The posteriorgram 275 may be sent to the decoder 280 and the prosody output head 290. The decoder 280 processes the posteriorgram 275 to generate the model output natural language data 125 corresponding to the natural language response to the user input. In some embodiments, the decoder 280 may correspond to a transformer decoder configured to generate natural language responsive to the prompt data 715. For example, the decoder 280 may process the posteriorgram 275 to predict a next word/token to be included in the model output natural language data 125. Thereafter, the decoder 280 processes the posteriorgram 275 and the predicted next word/token to generate a further predicted next word/token to be included in the model output natural language data 125. In some embodiments, the decoder 280 may repeat this process until the model output natural language data 125 is generated (e.g., an <end> token is generated by the decoder 280).

As discussed above, the posteriorgram 275 may be also sent to the prosody output head 290 of the prosody layers 130. The prosody output head 290 may further receive the intermediate prosody processing data 132n. The prosody output head 290 may process the posteriorgram 275 and the intermediate prosody processing data 132n to generate the model output prosody data 135 representing the one or more voice characteristics corresponding to a synthetic voice that is to be used to output the model output natural language data 125 to the user. In some embodiments, the prosody output head 290 may be a feed forward layer. The prosody output head 290 generates the model output prosody data 135 as a result of applying one or more weights (determined as a result of training the prosody output head 290 for the prosody prediction task) to the posteriorgram 275 and the intermediate prosody processing data 132n.

As discussed herein above, in some embodiments, the model output prosody data 135 may be a spectrogram, which may be determined as a result of the abovementioned processing of the prosody output head 290. As further discussed herein above, in some embodiments, the model output prosody data 135 may be natural language (e.g., textual and/or tokenized) representation of the prosody information. In such embodiments, the prosody layers 130 may further include a decoder (e.g., similar to the decoder 280, except trained for the task of prosody prediction) configured to process the output of the prosody output head 290 to generate the model output prosody data 135 corresponding to the natural language representation of the prosody information.

In some embodiments, as discussed herein above with respect to FIG. 1, additionally or alternatively to the natural language layers 120 sending the intermediate natural language processing data 122a-n to the prosody layers 130, the prosody layers 130 may send the intermediate prosody processing data 132a-n to the natural language layers 120 to be used during the processing of the natural language layers 120 to generate the model output natural language data 125. In such embodiments the natural language layers 120 may include one or more fusion layer(s) configured to receive the intermediate prosody processing data 132a-n, fuse the intermediate prosody processing data 132a-n and the intermediate natural language processing data 122a-n, and send the fused data to a next natural language transformer layer of the natural language layers 120.

In some embodiments, the natural language layers 120 may be trained as discussed herein above using an extensive dataset of at least text (or tokenized) data. In some embodiments, during the training of the prosody layers 130, the natural language layers 120 may be frozen. In other words, while the prosody layers 130 are being trained, the one or more weights of the natural language layers 120 may not be changed during the backpropagation of the prosody layers 130. As such, the weights of the natural language layers 120 are not changed while the prosody layers 130 are trained (and, therefore, the capability of the natural language layers 120 to perform the natural language generation task are not changed), but the prosody layers 130 can be trained for the prosody prediction task using the intermediate processing data 122a-n output by the layer(s) of the natural language layers 120. During training, the prosody layers 130 may be trained on a dataset of training data including natural language inputs (e.g., prompt data, user input, etc.), audio data including voice characteristics corresponding to the text, and fixed-length prosody vectors that correspond to the audio data, where the prosody layers 130 are tasked with generating the fixed-length prosody vectors using the natural language input. In some embodiments, the prosody layers 130 may be pre-trained (e.g., the prosody layers 130 may correspond to at least a portion of the natural language layers 120) and then fine-tuned for the prosody prediction task.

As discussed herein above, in some embodiments, the natural language and prosody LLM 117 may include layers that are configured to generate both of the model output natural language data 125 and the model output prosody data 135. In such embodiments, the layers may be trained for the joint task of natural language generation and prosody prediction.

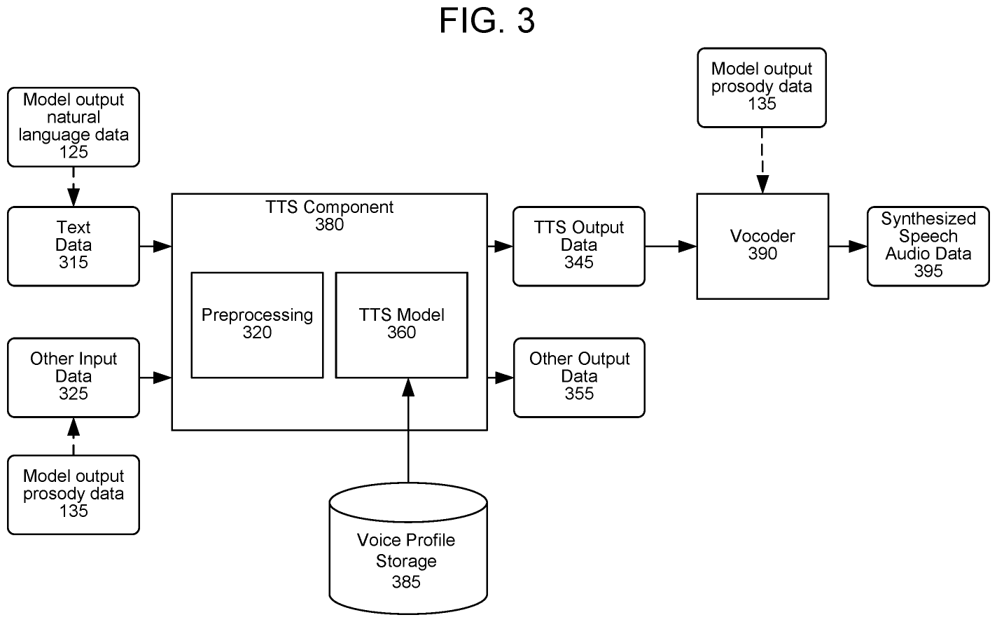

The model output natural language data 125 and the model output prosody data 135 may be sent to a TTS component 380 to generate audio data corresponding to the model output natural language data 125, where the model output natural language data 125 is spoken in a synthetic voice having a voice characteristic(s) corresponding to the model output prosody data 135, as is discussed in more detail herein below with respect to FIG. 3.

Components of a system that may be used to perform unit selection, parametric TTS processing, and/or model-based audio synthesis are shown in FIG. 3. FIG. 3 is a conceptual diagram that illustrates operations for generating synthesized speech using a TTS component 380, according to embodiments of the present disclosure. The TTS component 380 may receive text data 315 and process it using one or more TTS models 360 to generate TTS output data 345 representing synthesized speech. In some embodiments, the text data 315 may include/correspond to the model output natural language data 125. In some embodiments the TTS output data 345 may represent synthesized speech in the form of, for example, spectrogram data. In other embodiments, the TTS output data 345 may comprise other data, for example data representing a latent representation (e.g., embedding data) representing synthesized speech. A vocoder 390 or other component may convert the TTS output data 345 into output speech audio data 395, which may represent a time-domain waveform suitable for amplification and output as audio (e.g., from a loudspeaker).

The TTS component 380 may additionally receive other input data 325. The other input data 325 may include, for example, identifiers and/or labels corresponding to a desired speaker identity, voice characteristics, emotion, speech style, etc. desired for the synthesized speech. In some embodiments, the other input data 325 may include/correspond to the model output prosody data 135. In some implementations, the other input data 325 may include text tags or text metadata, that may indicate, for example, how specific words should be pronounced, for example by indicating the desired output speech quality in tags formatted according to the speech synthesis markup language (SSML) or in some other form. For example, a first text tag may be included with text marking the beginning of when text should be whispered (e.g., <begin whisper>) and a second tag may be included with text marking the end of when text should be whispered (e.g., <end whisper>). The tags may be included in the text data 315 and/or the other input data 325 such as metadata accompanying a TTS request and indicating what text should be whispered (or have some other indicated audio characteristic).

The TTS component 380 may include a preprocessing component 320 that can convert the text data 315 and/or other input data 325 into a form suitable for processing by the TTS model 360. The text data 315 may be from, for example an application, a skill component (described further below), an NLG component, another device or source, or may be input by a user. The text data 315 received by the TTS component 380 may not necessarily be text, but may include other data (such as symbols, code, other data, etc.) that may reference text (such as an indicator of a word and/or phoneme) that is to be synthesized. The preprocessing component 320 may transform the text data 315 into, for example, a symbolic linguistic representation, which may include linguistic context features such as phoneme data, punctuation data, syllable-level features, word-level features, and/or emotion, speaker, accent, or other features for processing by the TTS component 380. The syllable-level features may include syllable emphasis, syllable speech rate, syllable inflection, or other such syllable-level features; the word-level features may include word emphasis, word speech rate, word inflection, or other such word-level features. The emotion features may include data corresponding to an emotion associated with the text data 315, such as surprise, anger, or fear. The speaker features may include data corresponding to a type of speaker, such as sex, age, or profession. The accent features may include data corresponding to an accent associated with the speaker, such as Southern, Boston, English, French, or other such accent. Style features may include a book reading style, poem reading style, a news anchor style, a sports commentator style, various singing styles, etc.

The preprocessing component 320 may include functionality and/or components for performing text normalization, linguistic analysis, linguistic prosody generation, or other such operations. During text normalization, the preprocessing component 320 may first process the text data 315 and generate standard text, converting such things as numbers, abbreviations (such as Apt., St., etc.), symbols ($, %, etc.) into the equivalent of written out words.

During linguistic analysis, the preprocessing component 320 may analyze the language in the normalized text to generate a sequence of phonetic units corresponding to the input text. This process may be referred to as grapheme-to-phoneme conversion. Phonetic units include symbolic representations of sound units to be eventually combined and output by the system as speech. Various sound units may be used for dividing text for purposes of speech synthesis. In some implementations, the TTS model 360 may process speech based on phonemes (individual sounds), half-phonemes, di-phones (the last half of one phoneme coupled with the first half of the adjacent phoneme), bi-phones (two consecutive phonemes), syllables, words, phrases, sentences, or other units. Each word may be mapped to one or more phonetic units. Such mapping may be performed using a language dictionary stored by the system, for example in a storage component. The linguistic analysis performed by the preprocessing component 320 may also identify different grammatical components such as prefixes, suffixes, phrases, punctuation, syntactic boundaries, or the like. Such grammatical components may be used by the TTS component 380 to craft a natural-sounding audio waveform output. The language dictionary may also include letter-to-sound rules and other tools that may be used to pronounce previously unidentified words or letter combinations that may be encountered by the TTS component 380. Generally, the more information included in the language dictionary, the higher quality the speech output.

The output of the preprocessing component 320 may be a symbolic linguistic representation, which may include a sequence of phonetic units. In some implementations, the sequence of phonetic units may be annotated with prosodic characteristics. In some implementations, prosody may be applied in part or wholly by a TTS model 360. This symbolic linguistic representation may be sent to the TTS model 360 for conversion into audio data (e.g., in the form of Mel-spectrograms or other frequency content data format).

The TTS component 380 may retrieve one or more previously trained and/or configured TTS models 360 from the voice profile storage 385. A TTS model 360 may be, for example, a neural network architecture that may be described as interconnected artificial neurons or “cells” interconnected in layers and/or blocks. In general, neural network model architecture can be described broadly by hyperparameters that describe the number of layers and/or blocks, how many cells each layer and/or block contains, what activations functions they implement, how they interconnect, etc. A neural network model includes trainable parameters (e.g., “weights”) that indicate how much weight (e.g., in the form of an arithmetic multiplier) a cell should give to a particular input when generating an output. In some implementations, a neural network model may include other features such as a self-attention mechanism, which may determine certain parameters at run time based on inputs rather than, for example, during training based on a loss calculation. The various data that describe a particular TTS model 360 may be stored in the voice profile storage 385. A TTS model 360 may represent a particular speaker identity and may be conditioned based on speaking style, emotion, etc. In some implementations, a particular speaker identity may be associated with more than one TTS model 360; for example, with a different model representing a different speaking style, language, emotion, etc. in some implementations, a particular TTS model 360 may be associated with more than one speaker identity; that is, be able to produce synthesized speech that reproduces voice characteristics of more than one character. Thus, a first TTS model 360a may be used to create synthesized speech for the first speech-processing system component(s)a while a second, different, TTS model 360b may be used to create synthesized speech for the second speech-processing system component(s)b. In some cases, the TTS model 360 may generate the desired voice characteristics based on conditioning data received or determined from the text data 315 and/or the other input data 325. For example, a synthesized voice of the first speech-processing system component(s)a may be different from a synthesized voice of the second speech-processing system component(s)b.

The TTS component 380 may, based on an indication received with the text data 315 and/or other input data 325, retrieve a TTS model 360 from the voice profile storage 385 and use it to process input to generate synthesized speech. The TTS component 380 may provide the TTS model 360 with any relevant conditioning labels to generate synthesized speech having the desired voice characteristics. The TTS model 360 may generate spectrogram data 345 (e.g., frequency content data) representing the synthesized speech, and send it to the vocoder 390 for conversion into an audio signal.

The TTS component 380 may generate other output data 355. The other output data 355 may include, for example, indications or instructions for handling and/or outputting the synthesized speech. For example, the text data 315 and/or other input data 325 may be received along with metadata, such as SSML tags, indicating that a selected portion of the text data 315 should be louder or quieter. Thus, the other output data 355 may include a volume tag that instructs the vocoder 390 to increase or decrease an amplitude of the output speech audio data 395 at times corresponding to the selected portion of the text data 315. Additionally or alternatively, a volume tag may instruct a playback device to raise or lower a volume of the synthesized speech from the device's current volume level, or lower a volume of other media being output by the device (e.g., to deliver an urgent message).

In embodiments where the prosody layers 130 are configured to generate model output prosody data corresponding to a spectrogram, a latent representation of the voice characteristic(s), an acoustic representation of the voice characteristic(s), and/or some other proxy representation of the voice characteristic(s), the model output prosody data 135 may be received at the vocoder 390.

The vocoder 390 may convert the spectrogram data 345 (or the model output prosody data 135) into an audio signal (e.g., an analog or digital time-domain waveform) suitable for amplification and output as audio. The vocoder 390 may be, for example, a universal neural vocoder based on Parallel WaveNet or related model. The vocoder 390 may take as input audio data in the form of, for example, a Mel-spectrogram with 80 coefficients and frequencies ranging from 50 Hz to 12 kHz. The synthesized speech audio data 395 may be a time-domain audio format (e.g., pulse-code modulation (PCM), waveform audio format (WAV), p-law, etc.) that may be readily converted to an analog signal for amplification and output by a loudspeaker. The synthesized speech audio data 395 may consist of, for example, 8-, 16-, or 24-bit audio having a sample rate of 16 kHz, 24 kHz, 44.1 kHz, etc. In some implementations, other bit and/or sample rates may be used.

FIG. 4 illustrates further example components included in the system 100 configured to determine an action responsive to a user input. As shown in FIG. 4, the system may include a user device 410, local to a user 405, in communication with a system component(s) 420 via a network(s) 499. The network(s) 499 may include the Internet and/or any other wide- or local-area network, and may include wired, wireless, and/or cellular network hardware.

The system component(s) 420 may include various components, such as a large language model (LLM) orchestrator component 430, a personalized context component 465, and an action plan execution component 445. The LLM orchestrator component 430 may include a plan generation component 435, an LLM shortlister component 440, and a response arbitration component 460. In some embodiments, the response arbitration component 460 may implement/correspond to natural language and prosody LLM 117, which may be further configured to process as described herein below.

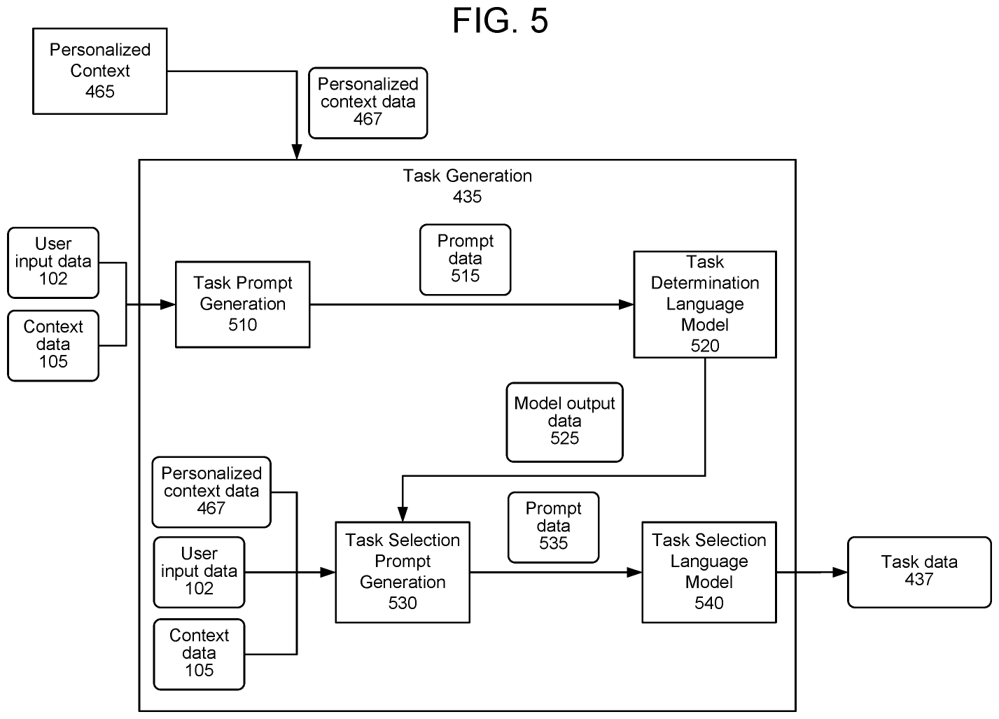

The user input data 102 may be received at the LLM orchestrator component 430 of the system component(s) 420, which may be configured to generate a list (e.g., one or more) of tasks (e.g., steps/actions) that are to be completed in order to perform an action responsive to the user input and select a task of the list of the tasks that is to be completed first (e.g., in a current iteration of processing by the system 100), as described in detail herein below with respect to FIG. 5. In instances where the plan generation component 435 generates more than one task to be completed in order to perform the action responsive to the user input, the plan generation component 435 may further maintain and prioritize the list of tasks as the processing of the system 100 with respect to the user input is performed. In other words, as the system 100 processes to complete the list of tasks, the plan generation component 435 may (1) incorporate the potential responses associated with completed tasks into data provided to other components of the system 100; (2) update the list of tasks to indicate completed (or attempted, in-progress, etc.) tasks; (3) generate an updated prioritization of the tasks remaining to be completed (or tasks to be attempted again); and/or (4) determine an updated current task to be completed. The plan generation component 435 may generate and send task data 437 representing the selected task to be completed and various other information needed to perform further processing with respect to the task (e.g., the user input data 102, an indication of the selected task, potential responses associated with previous tasks, the remaining task(s), and context data associated with the user input data 102, as described in detail herein below with respect to FIG. 5) to the LLM shortlister component 440.

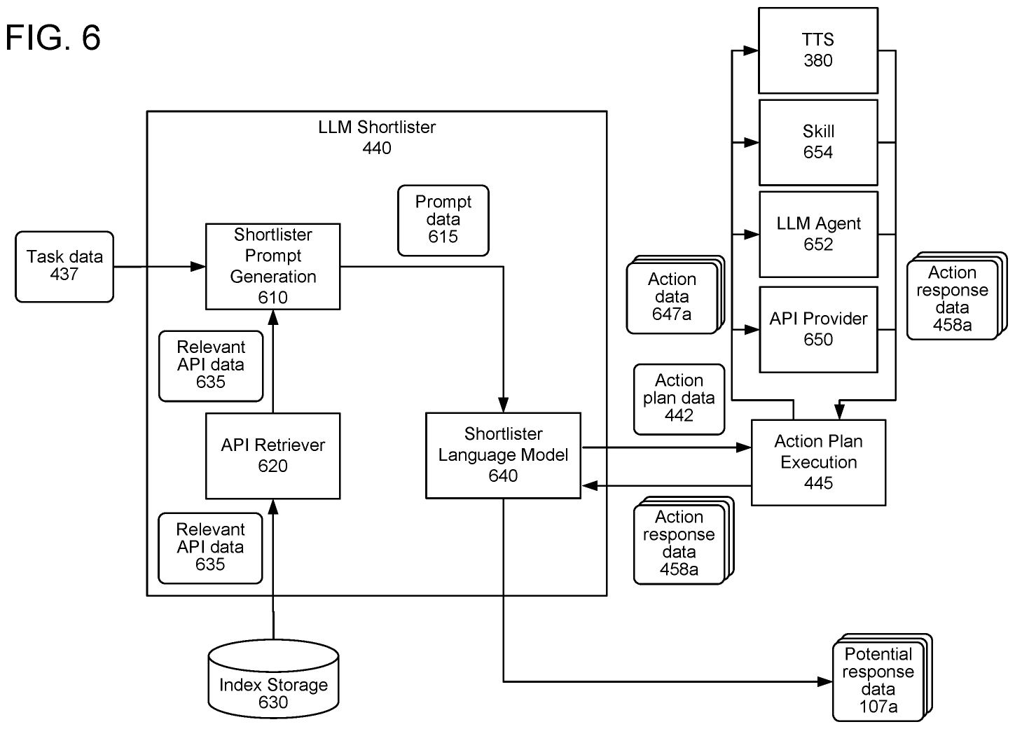

The LLM shortlister component 440 may be configured to determine one or more components (e.g., APIs, skill component(s) 654, LLM agent component(s) 652, TTS component 380, etc.) configured to perform an action related to the user input or the current task. The LLM shortlister component 440 may further be configured to generate and cause the execution of a request(s) (e.g., an API call(s), an incomplete API call/API call format, an indication of an action to be performed by a component, etc.) for the one or more components to provide a potential responses(s) to the user input or current task (e.g., a response to a user-provided question, a paragraph from a website, etc.), which may further include a potential action (e.g., a description of a potential action, such as turning on a light, booking a flight ticket, ordering a pizza, etc.) the components are configured to/will perform with respect to the user input or the current task). Such requests may be represented in the action plan data 442 sent to the action plan execution component 445. The action plan execution component 445 may identify the request(s) in the action plan data 442, generate executable API calls corresponding to the request(s), and cause the corresponding components (e.g., the API provider component 650, the LLM agent component 652, the skill component 654, and/or the TTS component 380) to generate action response data 458a-n representing the requested potential response(s), where individual action response data 458a may be provided by/correspond to a particular responding component—one of the API provider component 650, the LLM agent component 652, the skill component 4P4, and/or the TTS component 380. In some embodiments, the action response data 458a-n may include an identifier (e.g., a component name, an alphanumerical value associated with the component, etc.) for the component providing the data. The LLM shortlister component 440 receives and processes the action response data 458a-n and generates potential response data 443a-n representing the potential response(s) (e.g., relevant potential responses, selected potential responses, ranked potential responses, etc.) for further processing (e.g., as described in detail herein below with respect to FIG. 6). If the LLM shortlister component 440 determines that there are no remaining tasks to generate potential responses for, the LLM shortlister component 440 may send the potential response data 443a-n to the response arbitration component 460.

The potential response data 443a-n, in some embodiments, may be determined based on receiving potential responses from various different components that may be relevant in responding to the user input data 102. For example, the potential response data 443a-n may include a first potential response from a first component configured to perform a first task determined by the plan generation component 435, a second potential response from a second component configured to perform a second task determined by the plan generation component 435, etc. The potential response data 443a-n can include more than one potential response relating to an individual task. In some embodiments, the potential response data 443a-n may be natural language data.

The response arbitration component 460 processes the potential response data 443a-n to determine whether the potential responses generated for the one or more tasks are responsive to the user input. The response arbitration component 460 processes the potential response data 443a-n (representing at least the generated potential responses) and selects one or more of the potential responses that are determined to be responsive to the user input and/or determines that none of the actions are responsive to the user input. For example, the response arbitration component 460 may process the potential response data 443a-n to determine if one or more of the potential responses performable by the API(s) (e.g., the potential responses and/or potential actions) are responsive to the current task. In some embodiments, the response arbitration component 460 may generate a natural language summary of one or more of the selected responses and output the natural language summary. In some embodiments, for example where the response arbitration component 460 implements the natural language layers 120 and the prosody layers 130, the response arbitration component 460 may further output prosody information corresponding to the natural language summary.

FIG. 5 illustrates example processing of the plan generation component 435. As shown in FIG. 5, the plan generation component 435 may include a plan prompt generation component 510, a plan generation language model 520, a task selection prompt generation component 530, and a task selection language model 540.

As further shown in FIG. 5, the user input data 102 is received at the plan prompt generation component 510. The plan prompt generation component 510 processes the user input data 102 to generate prompt data 515 representing a prompt for input to the plan generation language model 520. In some embodiments, the plan prompt generation component 510 may further receive an indication of one or more remaining tasks to be completed with respect to the user input data 102. A task to be completed may correspond to a task for which the system 100 has yet to generate potential responses for (e.g., for which the API provider component 650, the LLM agent component 652, the skill component 4P4, and/or the TTS component 380 have yet to generate action response data for). Similarly, a completed task may correspond to a task for which the system 100 has generated potential responses for (for which the API provider component 650, the LLM agent component 652, the skill component 654, and/or the TTS component 380 have generated action response data). For example, if the current iteration of processing with respect to the user input data 102 is a subsequent iteration of processing (e.g., the system previously determined that more than one task is to be completed in order to perform an action responsive to the user input data 102 and has previously generated potential responses for at least a first task of the more than one tasks), then the plan prompt generation component 510 may further receive an indication of the remaining tasks to be completed. In such embodiments, the plan prompt generation component 510 may further receive an indication of the task(s) to complete processing for and/or the potential response(s) of the processing. The plan prompt generation component 510 may further receive the context data 105 representing the various contextual signals associated with the user input data 102, such as weather information, time of day, device information associated with the device that sent the user input data 102 (e.g., device ID, device states, historical device interaction data, etc.). Such prompt data 515 may be generated based on combining the user input data 102 and the context data 105 (and, in some embodiments, the indication of the remaining task(s), completed task(s), and/or the potential responses). In some embodiments, the prompt data 515 may be generated further based on the personalized context data 467.

The plan prompt generation component 510 may receive the personalized context data 467 from the personalized context component 465. As discussed herein above, the personalized context component 465 may be configured to determine and return contextual information associated with a user input to the plan prompt generation component 510, which the plan prompt generation component 510 may combine with the user input data 102 to generate the prompt data 515.

As discussed herein above, the personalized context component 465 may be caused to generate and return the personalized context data 467 based on the system 100 determining that additional information is needed in order to generate potential responses for a task associated with a user input. For example, one or more of the components of the system 100 (e.g., the plan generation language model 520, the task selection language model 540, the shortlister language model 640, the response arbitration component 460) may determine that an ambiguity exists in the user input (or the data determined/generated as a result of processing with respect to the user input). In such examples, the personalized context component 465 may receive the user input, the current task, and/or model output data indicating that an ambiguity exists/additional information should be determined (e.g., model output data representing “Does the user prefer to use [Music Streaming Service 1] or [Music Streaming Service 2] for playing music,” “I need to determine whether the user prefers [Music Streaming Service 1] or [Music Streaming Service 2] for playing music” or the like). The personalized context component 465 may process as described herein above to generate the personalized context data 467 (e.g., “The user prefers [Music Streaming Service 1].”)

In some embodiments, plan prompt generation component 510 (or another component of the system 100) may process the personalized context data 467, the user input data 102, and/or the potential responses associated with the user input data 102 to generate a natural language representation of the user input (represented by the user input data 102) that is updated to include the contextual information of the personalized context data 467 (e.g., a contextual rewrite of the user input). Thereafter, the plan prompt generation component 510 may process to generate the prompt data 515 using the updated user input data.

In some embodiments, the prompt data 515 may be an instruction for the plan generation language model 520 to determine one or more tasks (e.g., steps/actions) that are to be completed in order to perform an action responsive to the user input given the other information (e.g., the context data 105, the personalized context data 467, the indication of the remaining task(s), the indication of the completed task(s), and/or the corresponding potential responses) included in the prompt data 515.

In some embodiments, the plan prompt generation component 510 may also include in the prompt data 515 a sample processing format to be used by the plan generation language model 520 when processing the prompt. In some embodiments, the plan prompt generation component 510 may generate the prompt data 515 according to a template format. For example, the prompt data 515 may adhere to a template format of:

{
Create a new task if necessary to help complete a request to [user
input data 102 (or a representation of a determined intent of the
user input data 102].
Here are the completed tasks, the potential responses, user inputs,
and context so far:
[completed tasks, the potential responses, dialog history, context
data 105, personalized context data 467]
These are the remaining tasks to be completed:
[remaining task data]
Based on the result, create new tasks to be completed, if necessary.
Return the tasks as an array.
}

In some embodiments, the template format may instruct the plan generation language model 520 as to how it should process to generate the one or more tasks (e.g., steps) that are to be completed. In some embodiments, the format may further include an indication, such as a label of “User:” indicating the following string of characters/tokens as the user input. In some embodiments, the format may further include a label of “Thought:” instructing the plan generation language model 520 to generate an output representing the determined interpretation of the user input by the plan generation language model 520 and/or an action that should be taken (e.g., the user is requesting [intent of the user input], the user is trying to [intent of the user input], need to determine [information needed to properly process the user input], etc.). In some embodiments, the format may further include an indication of “Observation:” indicating the following string of characters/tokens as the result of performance of an action determined by the plan generation language model 520/the plan generation language model 520's interpretation of the result of the performance of the action determined by the plan generation language model 520 (e.g., the completed tasks and/or their potential responses). In some embodiments, the format may further include an indication of “Response:” instructing the plan generation language model 520 to generate a response (e.g., one or more tasks to be completed) to the prompt.

Following such a template format, for example, and for a user input of “turn on all of the lights except the garage,” the plan prompt generation component 510 may generate example prompt data 515a:

{
Create a new task if necessary to help complete a request to turn on
all of the lights except the garage.
Here are the completed tasks, their potential responses, user inputs,
and context so far:
[ ]
These are the remaining tasks to be completed:
[ ]
Based on the result, create new tasks to be completed, if necessary.
Return the tasks as an array.
}

As an example of a user input that is associated with more than one task, the system 100 may receive a user input of “please order some pizza for dinner” and may determine a task list of “identify user pizza preference” and “find application that enables ordering of pizza.” Thereafter, the system 100 may process as described herein below to select and complete the task of “identify user pizza preference.” The plan prompt generation component 510 may process the user input, corresponding context data, the remaining task list, and the potential responses (e.g., the users pizza preference, determined, for example, by the personalized context component 465) to generate example prompt data 515a:

{
Create a new task if necessary to help complete a request to order
some pizza for dinner.
Here are the completed tasks, their potential responses, user inputs,
and context so far:
Completed tasks:
Identify user pizza preference: user ordered Brooklyn style
pizza from [Company name]
These are the remaining tasks to be completed:
Find application to order pizza
Based on the result, create new tasks to be completed, if necessary.
Return the tasks as an array.
}

In some embodiments, the plan prompt generation component 510 may also include in the prompt data an instruction to output a response that satisfies certain conditions. Such conditions may relate to generating a response that is unbiased (toward protected classes, such as gender, race, age, etc.), non-harmful, profanity-free, etc. For example, the prompt data 515 may include “Please generate a polite, respectful, and safe response and one that does not violate protected class policy.”

The plan generation language model 520 processes the prompt data 515 to generate model output data 525 representing one or more predicted tasks to be completed in order to perform the action responsive to the user input. For example, based on processing the first example prompt data provided above, the plan generation language model 520 may output model output data 525a: {“turn on all of the lights except the garage light,” } or the like. For further example, as discussed above, based on processing prompt data corresponding to the user input “please order some pizza for dinner” the plan generation language model 520 may output model output data 525b: {“identify user pizza preference;” “find application that enables ordering of pizza,” or the like. After the first task of “identify user pizza preference” is complete, and based on processing the second example prompt data provided above, the plan generation language model 520 may further output model output data 525c: {“find an application to order pizza” “find API to order [Company name] pizza,”} or the like. In some embodiments, the threshold for determining the one or more tasks may be such that the plan generation language model 520 is encouraged to generate multiple predicted tasks for a given user input, where the system 100 may parse and filter the list of tasks during downstream processing (e.g., during the processing of the task selection language model 540). For example, based on processing the first example prompt data provided above, the plan generation language model 520 may output model output data 525d: {“turn on all of the lights except the garage light,” “turn on all lights,” “identify which garage light,” “turn on all lights then turn off garage light,” “turn on all lights where user is located,” “turn on kitchen lights, living room lights, dining room lights, hallways lights” “turn on all lights on first floor,” } or the like.

The model output data 525 is sent to the task selection prompt generation component 530, which processes the model output data 525 to generate prompt data 535 representing a prompt for input to the task selection language model 540. In some embodiments, such prompt data 535 may be generated based on combining the user input data 102, the context data 105, the personalized context data 467, the prompt data 515, and/or the model output data 525. In some embodiments, the plan generation component 435 may include another component that parses the model output data 525 to determine the one or more tasks and may send a representation of the one or more tasks to the task selection prompt generation component 530.

In some embodiments, the prompt data 535 may be an instruction for the task selection language model 540 to select a task of the one or more tasks that is to be completed first (e.g., completed during the current iteration of processing) given the information (e.g., user input data 102, the context data 105, the personalized context data 467, and the one or more tasks) included in the prompt data 535. In some embodiments, the prompt data 535 may further include an instruction for the task selection language model 540 to determine a priority of the one or more tasks (e.g., an ordered list representing the order in which the one or more tasks are to be completed). As discussed above, with respect to the plan prompt generation component 510, in some embodiments, the task selection prompt generation component 530 may also include in the prompt data 535 a sample processing format to be used by the task selection language model 540 when processing the prompt. Similarly, in some embodiments, the task selection prompt generation component 530 may generate the prompt data 535 according to a template format, such as:

{
Select the top prioritized task given the ultimate goal of [user input
data 102 (or a representation of a determined intent included in the
user input data 102]
Here are the completed tasks, their potential responses, and user
inputs so far:
[completed tasks, potential responses associated with the tasks,
dialog history, context data 105, personalized context data 467]
Here are the task candidates:
[remaining tasks]
Return your selected task, return None if the goal is achieved or
indicate existing ambiguities.
}

In some embodiments, the template format may instruct the task selection language model 540 as to how it should process to select the task and/or prioritize the one or more tasks. In some embodiments, as discussed above, the format may further include indications of the “User:”, “Thought:”, “Action:”, “Observation:”, and/or “Response:” indicators.

Following such a template format, for example, and for the first example user input provided above of “turn on all of the lights except the garage,” the task selection prompt generation component 530 may generate example prompt data 535a:

{
Select the top prioritized task given the ultimate goal of turn on all
of the lights except the garage
Here are the completed tasks, their potential responses, user inputs,
and context so far:
[ ]
Here are the task candidates:
Turn on all of the lights except the garage light
Return your selected task, return None if the goal is achieved or
indicate existing ambiguities.
}

For further example, for the second example user input provided above of “please order some pizza for dinner,” the task selection prompt generation component 530 may generate example prompt data 535b:

{
Select the top prioritized task given the ultimate goal of please
order some pizza for dinner
Here are the completed tasks, their potential responses, user inputs
and context so far:
Completed tasks:
Identify user pizza preference: user ordered Brooklyn style
pizza from [Company name]
Here are the task candidates:
find an application that sells pizza
find API that sells [Company name] pizza
Return your selected task, return None if the goal is achieved or
indicate existing ambiguities.
}

In some embodiments, the task selection prompt generation component 530 may also include in the prompt data an instruction to output a response that satisfies certain conditions. Such conditions may relate to generating a response that is unbiased (toward protected classes, such as gender, race, age, etc.), non-harmful, profanity-free, etc. For example, the prompt data may include “Please generate a polite, respectful, and safe response and one that does not violate protected class policy.”

The task selection language model 540 processes the prompt data 535 to generate model output data representing the task to be completed first and/or a prioritization of the one or more tasks. For example, based on processing the first example prompt data provided above, the task selection language model 540 may output model output data: {“1. Turn on all of the lights except the garage light,” } or the like. For further example, based on processing the second example prompt data provided above, the task selection language model 540 may output model output data: {“1. Find an API that sells [Company name] pizza,” } or the like. In some embodiments, during processing of the task selection language model 540 to select and/or prioritize the one or more tasks, the task selection language model 540 may update the task list to remove any redundant and/or conflicting tasks. For example, for the second example prompt data, the task selection language model 540 may determine that the remaining tasks of “find an application that sells pizza” and “find an API that sells [Company name] pizza” are redundant, and that “find an API that sells [Company name] pizza has a higher priority. Therefore, the task selection language model 540 may remove the task of “find an application that sells pizza” from the remaining task list. Thereafter, the plan generation component 435 (or another component of the plan generation component 435) may process the model output data of the task selection language model 540 to determine task data 437 representing the user input data 102, the personalized context data 467, and/or the task selected by the task selection language model 540 to be completed first. In some embodiments, the task data 437 may include the remaining one or more tasks and/or may indicate the prioritization of the one or more tasks, as determined by the task selection language model 540. The task data 437 may be sent to the LLM shortlister component 440, which is described in detail herein below with respect to FIG. 6.

FIG. 6 illustrates example processing of the LLM shortlister component 440. As shown in FIG. 6, the LLM shortlister component 440 may include an index storage 630, an API shortlister component 620, a shortlister prompt generation component 610, and a shortlister language model 640.

As further shown in FIG. 6, the task data 437 is received at the shortlister prompt generation component 610. The shortlister prompt generation component 610 processes the task data 437 to generate prompt data 615 representing a prompt for input to the shortlister language model 640. In some embodiments, such prompt data 615 may be generated based on combining the task data 437 (e.g., the user input data 102, the context data 105, the selected task, remaining tasks, potential responses associated with one or more previous tasks, etc.) and relevant API data 635 representing one or more APIs associated with the user input data 102 and/or the current task.

The relevant API data 635 may be generated by the API shortlister component 620, which may be configured to retrieve one or more (e.g., top-k) relevant APIs associated with the user input data 102 or the current task. In some embodiments, the APIs may correspond to various components. For example, the components may correspond to rule-based components, ML-based components, LLM-based components, or the like, such as the personalized context component 465, the skill component(s) 654, the LLM agent component(s) 652, the TTS component 380, the orchestrator component 830, etc.) In some embodiments, the APIs may correspond to the components.

The API shortlister component 620 may use retrieval-based approaches to retrieve the one or more relevant APIs from the index storage 630, which may store various information associated with multiple APIs such as API descriptions, API arguments (e.g., parameter inputs/outputs), identifiers for components (e.g., such as personalized context component 465, skill component(s) 654, LLM agent component(s) 652, TTS component 380) that provides the API, etc. For example, the API shortlister component 620 may compare one or more APIs included in the index storage 630 to the user input or the current task to determine one or more APIs (top-k) that corresponds to the user input or the current task (e.g., APIs that are semantically similar to the user input or the current task, APIs that are capable of performing the current task, etc.). In some embodiments, the API shortlister component 620 (or another component of the API shortlister component 620) may determine an encoded representation of the user input or the current task and compare (e.g., using cosine similarity) the encoded representation(s) to an encoded representation of an API description for the API to determine whether the API is semantically similar to the user input or the current task. An API description may correspond to a description of the one or more function that the API is configured to perform and/or other information associated with the API (e.g., an API call formatting structure (e.g., including input parameters), historical accuracy/defect rate, historical latency value, etc.). In some embodiments, the API description may further include one or more exemplars associated with use of the API (e.g., an example user input, corresponding API call, and example API output). If the value of semantic similarity meets or exceeds a threshold, the API (and, optionally, the API description) may be included in the relevant API data 635. In some embodiments, the API shortlister component 620 may determine the relevant API data 635 further using contextual information, including the personalized context data 467, an accuracy/defect rate value associated with the APIs, and/or a historical latency value associated with the APIs (e.g., which may be included in the description of the API). In some embodiments, the index storage 630 may be included in the API shortlister component 620. Similar processing may be performed to determine one or more components that are semantically similar to the user input or the current task, which may be included in the relevant API data 635. The API retrieval may send the relevant API data 635 to the shortlister prompt generation component 610.

In some embodiments, the prompt data 615 may be an instruction for the shortlister language model 640 to determine one or more APIs that are to process with respect to the user input or the current task (e.g., determine one or more API calls to cause the APIs to process) given the information (e.g., the user input data 102, the personalized context data 467, the current task, and the relevant API data 635). As discussed above, with respect to the plan prompt generation component 510 and the task selection prompt generation component 530, in some embodiments, the shortlister prompt generation component 610 may also include in the prompt data 615 a sample processing format to be used by the shortlister language model 640 when processing the prompt. Similarly, in some embodiments, the shortlister prompt generation component 610 may generate the prompt data 615 according to a template format, such as:

{
You are an AI agent to find and execute an API to complete the
task of [user input data 102 / current task]
Here is a list of relevant API available:
[relevant API data 635]
Use the following format:
Thought: think about what to do
API: API calls compatible with the task
Observation: the result of the API call
Summary: summarized results from the API call
If no appropriate API is found, summarize as nothing is found.
}

Following such a template format, for example, and for a selected task of “turn on all of the lights except the garage light” and corresponding relevant API data, the shortlister prompt generation component 610 may generate example prompt data 615a:

{
You are an AI agent to find an execute an API to complete the task
of turn on all of the lights except the garage light
Here is a list of relevant API available:
Let's chat API
Classic NLU API
Smart Home skill
Use the following format:
Thought: think about what to do
API: API calls compatible with the task
Observation: the result of the API call
Summary: summarized results from the API call
If no appropriate API is found, summarize as nothing is found.
}

In some embodiments, the shortlister prompt generation component 610 may also include in the prompt data an instruction to output a response that satisfies certain conditions. Such conditions may relate to generating a response that is unbiased (toward protected classes, such as gender, race, age, etc.), non-harmful, profanity-free, etc. For example, the prompt data may include “Please generate a polite, respectful, and safe response and one that does not violate protected class policy.”

The shortlister language model 640 processes the prompt data 615 to generate one or more API calls corresponding to request(s) that the corresponding APIs return a potential response to the user input/current task and/or a potential action(s) that the APIs are configured to/will perform with respect to the user input and/or the current task (e.g., a natural language description of the potential action(s)). As such, in some embodiments, the shortlister language model 640 may generate API calls for a subset of the APIs represented in the prompt data 615.

The shortlister language model 640 may generate the one or more APIs calls (including the required input parameters) by applying in-context learning for cold-starting APIs (e.g., one-shot/few-shot learning). For example, in embodiments where the relevant API data 635 includes the API descriptions, the shortlister language model 640 may use the one or more exemplars included in the API descriptions (included in the prompt data 615) to determine the one or more input parameters for the API call. In some embodiments, the shortlister language model 640 may be finetuned on such exemplars (e.g., during offline or runtime processing), such that the shortlister language model 640 is capable of determining the one or more input parameters for the given API call.

During processing of the shortlister language model 640 and after generating the one or more requests, the shortlister language model 640 may cause the one or more requests to be executed. For example, as shown in FIG. 6, the shortlister language model 640 may send action plan data 442 representing the one or more requests to the action plan execution component 445, which causes execution of the one or more requests included in the action plan data 442. For example, the action plan execution component 445 may process the action plan data 442 to generate action data 647a-n. Action data 647a may represent, for example, an instruction (e.g., an executable API call determined from/generated based on the action plan data 442) for a particular API to process with respect to the user input and/or the current task. In embodiments where the action plan data 442 includes requests corresponding to incomplete API calls, API call formats, indications of actions to be performed by one or more components, the action plan execution component 445 may be configured to generate executable API calls corresponding to the action plan data 442. In some embodiments, the action plan execution component 445 may generate the action data 647a-n to represent an instruction to provide the responses including the potential response(s)/potential action(s) with respect to the user input and/or the current task.

The action plan execution component 445 may send the action data 647a-n to the API provider component 650, the LLM agent component 652, the skill component 654, and/or the TTS component 380. The API provider component 650 may include one or more components (e.g., rule-based components, ML-based components, LLM-based components, or the like) that may be caused to process using the action data 647a-n (e.g., using the API calls generated by the LLM shortlister component 440).

The skill component 654 may be software running on the system component(s) 420 that is akin to a software application. That is, a skill component 654 may enable the system component(s) 420 to execute specific functionality in order to provide data or produce some other requested output. As used herein, a “skill component” may refer to software that may be placed on a machine or a virtual machine (e.g., software that may be launched in a virtual instance when called). A skill component may be software customized to perform one or more actions as indicated by a business entity, device manufacturer, user, etc. What is described herein as a skill component may be referred to using many different terms, such as an action, bot, app, or the like. The system component(s) 420 may be configured with more than one skill component 654. For example, a weather service skill component may enable the system component(s) 420 to provide weather information, a car service skill component may enable the system component(s) 420 to book a trip with respect to a taxi or ride sharing service, a restaurant skill component may enable the system component(s) 420 to order a pizza with respect to the restaurant's online ordering system, etc. A skill component 654 may operate in conjunction between the system component(s) 420 and other devices, such as the user device 410, in order to complete certain functions. A skill component 654 may include hardware, software, firmware, or the like that may be dedicated to a particular skill component 654 or shared among different skill components 654.

The LLM agent component 652 may correspond to one or more LLM agents. An LLM agent component 652 may correspond to a custom instantiation of an LLM (and other components) that is configured to handle user inputs relating to a particular domain/functionality. In some embodiments, the LLM agent component 652 may be configured to handle specific use cases via particular prompt generation, fine-tuning of the LLM, etc. For example, the LLM agent component 652a may be configured to handle user inputs/tasks related to information query, the LLM agent component 652b may be configured handle user inputs/tasks related to shopping, the LLM agent component 652c may be configured to handle user inputs/tasks related to ordering food from various restaurants, the LLM agent component 652d may be configured to handle user inputs/tasks related to ordering food from a particular restaurant (e.g., a particular pizza restaurant), the LLM agent component 652e may be configured to handle user inputs/tasks related to booking a hotel, the LLM agent component 652f may be configured to handle user inputs/tasks related to booking a flight, etc.

The API provider component 650 may include various components that may be caused to execute using the action data 647a-n. For example, the API provider component 650 may include an entity recognition (ER) component, which may be configured to process textual or tokenized input to link one or more entity references included in the textual or tokenized input to a specific corresponding entity known to the system 100. For example, based on the textual or tokenized input (e.g., a context of the textual or tokenized input), the ER component may determine that a reference to “Neil Armstrong” is directed to the American astronaut. In some embodiments, the action data 647a-n may include an indication(s) (e.g., slots) of one or more entities included in the user input, as determined by one or more of the language models 520, 540, 640, in which case the ER component may process to link the one or more entities to the specific, referenced, entity known to the system 100.

In other embodiments, the ER component may be configured to process the action data 647a-n to determine the one or more entities included in the user input and link the one or more determined entities to the specific, referenced, entity (entities) known to the system 100. For example, the ER component may include one or more recognizers. Each recognizer may include a named entity recognition (NER) component. The NER component applies grammar information and lexical information (received from a storage) associated with a domain (associated with the recognizer implementing the NER component) to determine a mention of one or more entities in text data. In this manner, the NER component identifies “slots” (each corresponding to one or more particular words in text data) that may be useful for later processing. The NER component may also label each slot with a type (e.g., noun, place, city, artist name, song name, etc.). Thereafter, the ER component links a slot of text data to a specific entity known to the system. To perform entity resolution, the ER component may utilize gazetteer information stored in an entity library storage. The gazetteer information may be used to match text data (representing a portion of the user input) with text data representing known entities, such as song titles, contact names, etc. Gazetteers may be linked to users (e.g., a particular gazetteer may be associated with a specific user's music collection), may be linked to certain domains (e.g., a shopping domain, a music domain, a video domain, etc.), or may be organized in a variety of other ways.

For further example, the API provider component 650 may include a search component, which may be configured to query a storage (e.g., a database, repository, knowledge base, etc.) for information usable for generating a response to a user input. For example, if the action data 647a-n represents a request for information of “Who won the game between [Team 1 Name] and [Team 2 Name],” then the search component may query the storage (or other sources, such as the Internet), to retrieve the information “[Team 1 Name] won the game between [Team 1 Name] and [Team 2 Name].”

As an even further example, the API provider component 650 may include the device controller component discussed herein above, which may be further configured to cause a device to perform an action corresponding to the action data 647a-n.

In some embodiments, the API provider component 650 may include a domain service component, which may be configured for interacting with one or more services defined by particular users, such as developers, specialists, or the like (e.g., to receive information, such as responses or annotations, to cause an action.

The API provider component 650, the LLM agent component 652, the skill component 654, and/or the TTS component 380 may send action response data 458a-n representing one or more potential responses generated by the one or more APIs corresponding to the action data 647a-n (e.g., the potential response(s) and/or potential action(s)) to the action plan execution component 445. For example, in response to an API call to the skill component 654 associated with a user input for turning on a light, the action response data 458a may correspond to a potential action of “turn on the light,” “turn_on_device (“light”, [device ID])”, or the like. For further example, in response to an API call to the skill component 654 associated with a user input for ordering a pizza from a particular restaurant, the action response data 458b may correspond to a potential action of “order medium pizza from [restaurant name]”, “order_pizza (“medium”, “pizza”, “[restaurant name]”)”, or the like. The action plan execution component 445 may send the action response data 458a-n to the shortlister language model 640.

In some embodiments, the shortlister language model 640 may process the action response data 458a-n to generate a natural language summary of the action response data (e.g., the potential response data 443a-n). In some embodiments, the potential response data 443a-n may include an association between action response data 458a (or a summarized representation of the action response data 458a) and an indication of the API/component that generated the action response data 458a (e.g., a component identifier, API description, etc.). In some embodiments, the shortlister language model 640 may be configured to filter and/or rank the action response data 458a-n based on how relevant the action response data 458a-n is to the current task. In some embodiments, the shortlister language model 640 may be configured to filter and/or rank the action response data 458a-n based on a confidence level of the component that provided the action response data, where the confidence level may indicate a likelihood of the component being able to respond (e.g., within a period of time), the component being able to perform a potential action that corresponds to the current task, etc. In some embodiments, the action response data 458a-n may indicate whether or not the corresponding component is able to respond (e.g., the action response data 458a may include a Boolean value such as “yes” or “no” or other similar indications). In some embodiments, the shortlister language model 640 may filter and/or rank the action response data 458a-n based on information included in the prompt data 615 (e.g., the user input data 102, the relevant API data 635, the context data 105 the personalized context data 467, the prompt data 515, etc.). For example, the potential response data 443a-n may include a subset of the action response data 458a-n (or the summarized representations of the action response data 458a-n) and may further include a representation of a confidence associated with the action response data 458a (or a summarized representation of the action response data 458a). As such, the potential response data 443a-n may further include data representing a confidence of how relevant the action response data 458a is to the current task. In some embodiments, the shortlister language model 640 may consider a rating associated with the component that provided the action response data 458a, where the rating may be a user satisfaction rating provided by multiple different users of the system 100, a user satisfaction rating provided by the user 405 associated with the user input data 102, a system generated rating based on the number of past tasks handled by the component, a accuracy rating based on the number of past tasks the component had handled correctly/provided a desired response for, etc.

The LLM shortlister component 440 may send the potential response data 443a-n for further processing. In instances where the plan generation component 435 determined that more than one task is to be completed, the LLM shortlister component 440 may send the potential response data 443a-n to the plan generation component 435, which may process as described herein above to maintain and prioritize the task list based on the potential response data 443a-n and select a new task to be completed. In instances where the plan generation component 435 determined that only one task is to be completed, or in instances where the LLM shortlister component 440 determines that there are no remaining tasks to be completed, the LLM shortlister may send the potential response data 443a-n, and the potential responses associated with previously completed tasks (e.g., previous action response data) to the response arbitration component 460 to process as discussed herein above. The LLM shortlister component 440 may further send the user input data 102, the context data 105, the personalized context data 467, etc., to the plan generation component 435 and/or the response arbitration component 460.

In some embodiments, the LLM orchestrator component 430 may further include a memory storage (not illustrated) which may store various information associated with the processing performed (e.g., user input data 102, the prompt data 515, the context data 105, the personalized context data 467, the model output data 525, prompt data 535, the task data 437, the relevant API data 635, the prompt data 615, the action plan data 442, the action response data 458a-n, the potential response data 443a-n, etc.) during one or more previous iterations of processing by the LLM orchestrator component 430 for the user input data 102. As such, after the LLM shortlister component 440 generates the potential response data 443a-n, the LLM orchestrator component 430 may send the abovementioned data to the memory storage. In some embodiments, the above-mentioned data may be sent to the memory storage as it is generated by the system 100.

In such embodiments, one or more of the prompt generation components discussed herein may be configured to include (e.g., append) one or more portions of the data included in the memory storage in the data (e.g., the generated prompts) to the corresponding language models. For example, during a subsequent iteration of processing, the plan prompt generation component 510 may receive one or more portions of the data included in the memory storage (which were generated during one or more previous iterations of processing performed with respect to the user input data 102) and include the one or more portions of data in the prompt data 515.

As discussed herein above, the shortlister language model 640 may be configured to determine whether additional information is needed in order to complete the current task (e.g., if an ambiguity exists in the user input data 102 or the current task, if the current task is to resolve an identified ambiguity, if an API argument is missing from the user input or other available data, etc.), in which case the shortlister language model 640 may send data representing a request for such additional information to the response arbitration component 460. In some embodiments, the action plan data 442 may represent the request for additional information, and the action plan execution component 445 may be configured to send corresponding action data 647a-n to the personalized context component 465. For example, for the example provided herein above with respect to ordering pizza, the shortlister language model 640 may determine that in order to resolve an ambiguity with respect to the user input data 102 or current task (e.g., based on the current task being to resolve the ambiguity or a determination that the current task cannot be completed due to the ambiguity), the system 100 must “identify user pizza preference,” or the like. The system 100 may send a request to the personalized context component 465 to “identify user pizza preference” and the personalized context component 465 may process as described herein above to return personalized context data resolving the ambiguity (e.g., the user's pizza preference may be determined to be a cheese pizza or a pepperoni pizza).

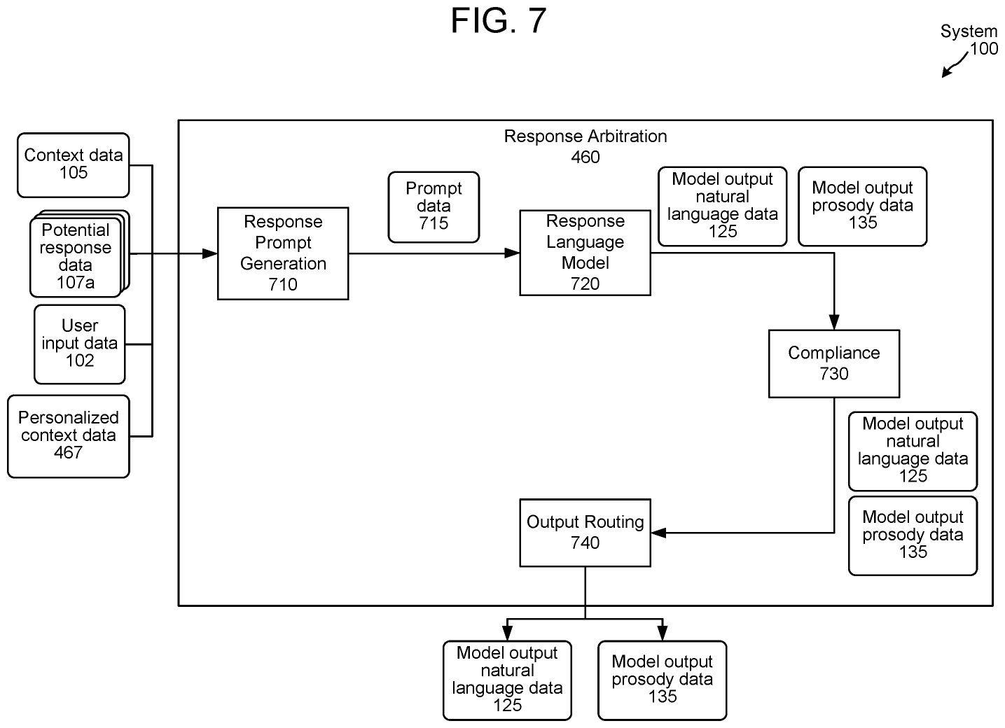

FIG. 7 illustrates example components and processing of the response arbitration component 460. As shown in FIG. 7, the response arbitration component 460 may include a response prompt generation component 710, a response language model 720, a compliance component 730, and an output routing component 740. As discussed herein above, the response arbitration component 460 processes the potential response data 443a-n (representing the potential responses generated by the one or more components determined to be associated with the user input) to determine whether one or more of the potential responses generated by the system 100 are responsive to the user input. The response arbitration component 460 may then generate the natural language response to the user input and corresponding prosody information, as discussed herein above.

As shown in FIG. 7, the response arbitration component 460 receives the potential response data 443a-n (output by the LLM shortlister component 440) at the response prompt generation component 710. The response prompt generation component 710 may further receive the user input data 102, the personalized context data 467 (from the LLM shortlister component 440 or the personalized context component 465) and the context data 105.

The personalized context data 467 may represent one or more contextual signals associated with the user 405, such as information associated with a user profile of the user 405 (e.g., user ID, user behavioral information, user preferences, age, gender, historical user interaction data, devices associated with the user profile, etc.), which may be determined using, for example, a user recognition component 895. In some embodiments, an indication of the user 405 and/or user profile may be included in the user input data 102 (e.g., as included in the output of the ASR component 850.). In some embodiments, the personalized context data 467 may include dialog history data representing one or more user inputs and corresponding system-generated responses for a current interaction between the user 405 and the system 100.

The response prompt generation component 710 may process the potential response data 443a-n, the user input data 102, context data 105, and the personalized context data 467 (and, optionally, the further information received from the LLM shortlister component 440) to generate prompt data 715 representing a prompt for input to the response language model 720. In some embodiments, the prompt data 715 may be an instruction for the response language model 720 to determine whether one or more of the potential responses represented in the potential response data 443a-n are responsive to the user input given the other information (e.g., the personalized context data 467, the context data 105, the potential responses associated with the previous tasks (e.g., previous action response data) associated with the user input, and the user input data 102) included in the prompt data 715. The prompt data may further be an instruction for the response language model 720 to, if the response language model 720 determines that one or more of the potential responses are responsive to the user input, cause performance of the one or more corresponding actions (e.g., the one or more potential actions included in the selected responses) and/or cause the system 100 to inform the user 405 of the one or more selected responses. For example, in some embodiments, prompt data 715 may further instruct the response language model 720 to generate a natural language summary of the one or more selected responses determined to be responsive to the user input. The prompt data 715 may instruct the response language model 720 to cause the system 100 to output the natural language summary to the user 405.

In some embodiments, the prompt data 715 may further be an instruction for the response language model 720 to, if the response language model 720 determines that none of the potential responses are responsive to the user input, generate a request for additional information from a component of the system 100 and/or the user 405. As discussed above, the additional information may be any information usable to determine and/or perform an action responsive to the user input (e.g., to resolve an ambiguity associated with the user input and/or a task(s) associated with the user input).

In some embodiments, the response prompt generation component 710 may also include in the prompt data 715 a sample processing format to be used by the response language model 720 when processing the prompt. In some embodiments, the response prompt generation component 710 may generate the prompt data 715 according to a template format. For example, the prompt data 715 may adhere to a template format including:

{
You are a conversational AI agent that communicates with users to
satisfy their request or ask clarification questions. If applicable,
summarize the responses that satisfy the user's request. If
applicable, call the corresponding API's to perform the potential
actions that satisfy the user's request. If no response is needed,
indicate that.
Here is the user's request:
[user input data 102]
Here is the context:
[context data 105, personalized context data 467]
Here are the potential responses:
[potential response data 443a-n]
}

In some embodiments, the template format may instruct the response language model 720 as to how it should process to determine whether one or more of the potential responses are responsive to the user input. In some embodiments, the format may further include an indication, such as a label of “User:” indicating the following string of characters/tokens as the user input. In some embodiments, the format may further include a label of “Thought:” instructing the response language model 720 to generate an output representing whether one or more of the potential responses are determined to be responsive to the user input or whether additional information is needed. In some embodiments, the format may further include an indication of “Response:” instructing the response language model 720 to indicate the one or more selected responses determined to be responsive to the user input, generate a summary of the one or more selected responses, and/or generate a request for additional information.

Following such a template format, for example, and for the example user input of “What is the weather for today” and corresponding potential responses output by the LLM shortlister component 440, the response prompt generation component 710 may generate example prompt data 715a:

{
“You are a conversational AI agent that communicates with users
to satisfy their request or ask clarification questions. If applicable,
summarize the responses that satisfy the user's request. If
applicable, call the corresponding API's to perform the potential
actions that satisfy the user's request. If no response is needed,
indicate that.”
Here is the user's request:
What is the weather for today
Here are the potential responses and potential actions:
Skill component A: It is currently 70 degrees, with a high of 75
and a low of 68
Skill component B: The weather for today is expected to be mostly
sunny, but with a chance of rain in the late afternoon
}

For further example, and for the example user input of “please order some pizza for dinner” and corresponding potential responses output by the LLM shortlister component 440, the response prompt generation component 710 may generate example prompt data 715b:

{
“You are a conversational AI agent that communicates with users
to satisfy their request or ask clarification questions. If no response
is needed, indicate that.”
Here is the user's request:
Please order some pizza for dinner
Here are the potential responses and potential actions:
Component A: User ordered Brooklyn style pizza from [Company
1 name]
API A: Use [Application 1 name] to order pizza from [Company 1
name]
API B: Use [Application 2 name] to order pizza from [Company 2
name]
}

In some embodiments, the response prompt generation component 710 may also include in the prompt data an instruction to output a response that satisfies certain conditions. Such conditions may relate to generating a response that is unbiased (toward protected classes, such as gender, race, age, etc.), non-harmful, profanity-free, etc. For example, the prompt data 715 may include “Please generate a polite, respectful, and safe response and one that does not violate protected class policy.”

The response language model 720 processes the prompt data 715 to generate the model output natural language data 125 representing the one or more selected responses determined to be responsive to the user input, the natural language summary of the one or more selected responses, the request for additional information, and the model output prosody data 135 corresponding to the prosody information corresponding to the selected responses/natural language summary. In embodiments where the response language model corresponds to the natural language layers 120 and the prosody layers 130, the response language model 720 may further output prosody information corresponding to the selected responses/natural language summary/request for additional information.

If the response language model 720 determines that one or more of the potential responses are responsive to the user input, the response language model 720 may generate the model output natural language data 125 representing the one or more selected responses, or a natural language summary of the one or more selected responses, to be output to the user. For example, based on processing the first example prompt data above, the response language model 720 may select one of the potential responses (e.g., the potential responses from skill component A (e.g., a weather skill component)) determined to be responsive to the user input to generate the model output natural language data 125 and the model output prosody data 135a: {“It is currently 70 degrees, with a high of 75 and a low of 68,” } or the like. For further example, based on processing the first example prompt data provided above, the response language model 720 may select more than one of the potential responses (e.g., the potential responses from both the skill component A and skill component B) determined to be responsive to the user input and generate a summary of the selected responses to generate the model output natural language data 125b: {“It is expected to be mostly sunny today, with a high of 75 and a low of 68, but with a chance of rain in the late afternoon,” } or the like. The response language model 720 may further output model output prosody data 135b indicating that the model output natural language data 125b is to be output to the user 405 in the voice of a weatherman.

As another example, based on processing the second example prompt data provided above, the response language model 720 may select one of the potential responses (e.g., the potential response from Component A (e.g., the personalized context component 465) representing that the user order Brooklyn style pizza from [Company 1 name]) determined to be responsive to the user input to generate the model output natural language data 125 and the model output prosody data 135a: {“Ok, I will place an order for Brooklyn style pizza from [Company 1 name],” } or the like. As a further example, based on processing the second example prompt data provided above, the response language model 720 may select more than one of the potential responses (e.g., the potential responses from both component A and API A) determined to be responsive to the user input and generate a summary of the selected responses to generate the model output natural language data 125 and the model output prosody data 135b: {“Ok, I will place an order for Brooklyn style pizza from [Company name] using [Application 1 name],” } or the like.

As such, the response language model 720 may select between the one or more potential responses from one or more different components (e.g., for the first example prompt data, the potential responses from the skill component A and the skill component B and, for the second example prompt data, the potential responses from Component A, API A, and API B) to determine that a subset of the potential responses are responsive to the user input. Thereafter, the response language model 720 may cause output of the selected responses (e.g., the subset of potential responses) or a natural language summary of the selected responses to the user in a synthetic voice corresponding to the model output prosody data 135.

In some embodiments, the response arbitration component 460 may also generate and send an instruction to the components, (e.g., API(s), components, agents, etc.) configured to perform the potential actions included in the selected responses to cause performance of the potential actions (or another component of the system 100 configured to cause the components to perform the potential actions, such as the action plan execution component 445, which is discussed in more detail herein below). For example, in instances where the selected responses include a potential action to be performed, the response language model 720 may further cause the corresponding components to perform the potential action (e.g., cause API A to order the Brooklyn style pizza from [Company 1 name] using [Application 1 name]). In other embodiments, the system 100 may not generate and/or send the instruction until approval to perform the action(s) is received from the user 405.

If the response language model 720 determines that none of the potential responses are responsive to the user input and/or that an ambiguity exists with respect to the user input and/or one or more of the determined tasks, the response language model 720 may generate the model output natural language data 125 to represent a request to be output to the user and/or the personalized context component 465. For example, based on processing the first example prompt data provided above, the response language model 720 may determine an ambiguity exists with respect to the size of the pizza to be ordered and may generate the model output natural language data 125c: {“What size pizza should I order?”,}{“What size pizza does the user usually order?”,} or the like to be output to the user and/or sent to the personalized context component 465. The response language model 720 may further output model output prosody data 135c indicating that the model output natural language data 125c is to be output to the user 405 using an inquisitive voice.

The response language model 720 may send the model output natural language data 125 and the model output prosody data 135 to the compliance component 730, which is configured to determine whether model output data generated by the response language model 720 is appropriate for output to the user 405. In other words, the compliance component 730 processes the model output natural language data 125 and the model output prosody data 135 to determine whether the model output natural language data 125 and the model output prosody data 135 includes any inappropriate/sensitive information that should not be output to the user 405 (e.g., confidential information, offensive language, etc.). In some embodiments, the compliance component 730 may be configured to compare the model output natural language data 125 and the model output prosody data 135 to one or more words determined to be inappropriate/sensitive and should not be output to the user 405. In some embodiments, the compliance component 730 may include/implement an ML model. For example, the ML model may process the model output natural language data 125 and the model output prosody data 135 to determine whether the model output natural language data 125 and the model output prosody data 135 includes any inappropriate/sensitive information. During training, the ML model may take as input a plurality of training natural language inputs, where the ML model is tasked with classifying a natural language input as including inappropriate/sensitive information or not. The output of the ML model (e.g., 0, 1, a value between 0 and 1, or the like) resulting from processing with respect to a training natural language input may be compared to a corresponding label representing whether the natural language input includes inappropriate/sensitive information or not. Based on the comparison, one or more parameters of the ML may be configured. In some embodiments, the ML model may be a classifier.

If the output of the compliance component 730 indicates that the model output natural language data 125 and the model output prosody data 135 includes information that is not appropriate for output to the user 405, the compliance component 730 may cause further processing of the model output natural language data 125 and the model output prosody data 135 by downstream components to halt. In some embodiments, the response arbitration component 460 may cause the response language model 720 to generate new model output natural language data and model output prosody data to be evaluated by the compliance component 730. For example, the response arbitration component 460 may cause the response prompt generation component 710 to generate new prompt data, which may include the prompt data 715, the model output natural language data 125 and the model output prosody data 135, and an indication that the model output natural language data 125 and the model output prosody data 135 are not appropriate for output to the user 405. The new prompt data may be an instruction to generate new model output data that is appropriate for output to the user 405.

If the output of the compliance component 730 indicates that the model output natural language data 125 and the model output prosody data 135 are appropriate for output to the user, the compliance component 730 may send the model output natural language data 125 and the model output prosody data 135 to the output routing component 740. The output routing component 740 processes the model output natural language data 125 and the model output prosody data 135 to determine one or more components that are to be caused to process in response to the model output natural language data 125 and the model output prosody data 135. In other words, the output routing component 740 parses the model output natural language data 125 and the model output prosody data 135 to determine one or more components that the model output natural language data 125 and the model output prosody data 135 is to be routed to (or that are to be caused to process based on the model output natural language data 125 and the model output prosody data 135).

For example, in an instance where the response language model 720 determines that one or more of the potential responses are responsive to the user input and generates the model output natural language data 125 and the model output prosody data 135 including the one or more selected responses (or a natural language summary of the one or more selected responses)/the request for additional information, the output routing component 740 may parse the model output natural language data 125 and the model output prosody data 135 to determine the selected responses/the natural language summary and send the model output natural language data 125 and the model output prosody data 135 to a component configured to generate corresponding data to be output to the user 405. For example, the output routing component 740 may send the model output natural language data 125 and the model output prosody data 135 to the TTS component 380, which may process as described herein above to generate output audio data including synthesized speech corresponding to the model output natural language data 125 and the model output prosody data 135, which the system 100 may send to the user device 410 for output to the user 405. In some embodiments, the system 100 may further include a component configured to generate visual output data (e.g., output image and/or video data) corresponding to the model output natural language data 125 and the model output prosody data 135, which may be sent to the user device 410 to be output to the user.

For further example, in embodiments where the model output natural language data 125 includes selected responses that include one or more potential actions to be performed, the output routing component 740 may process as described herein above to determine the one or more selected responses/the natural language summary and send the model output natural language data 125 to the one or more components associated with the selected responses. In such embodiments, the model output natural language data 125 may further include an instruction for the one or more components to perform the potential actions corresponding to the selected responses. For example, in some embodiments, the components corresponding to the potential responses included in the potential response data 443a-n may, after generating the potential responses, suspend processing required to perform the potential action included in the potential responses and await an instruction from the system 100 to perform the potential action. As such, the output routing component 740 may include the instruction in the model output natural language data 125 to cause the component to perform the potential action. In some embodiments, the output routing component 740 may generate an API call configured to cause the component to perform the action.

In some embodiments, where the model output natural language data 125 includes selected responses that include one or more potential actions to be performed, the model output natural language data 125 may further request authorization from the user 405 to perform the one or more potential actions responsive to the user input. After receiving the request authorization (e.g., via a subsequent user input) the response arbitration component 460 may generate and send the corresponding instruction (or API call) to perform the one or more potential actions responsive to the user input. In some embodiments, the system 100 may store data indicating prior authorization to perform the one or more potential actions responsive to the user input (or one or more actions similar to the one or more potential actions), in which case the response arbitration component 460 may use such data as authorization to perform the one or more potential actions. For example, the user 405 may have previously provided authorization for a set of actions (e.g., turning on outside lights). Thereafter, the system 100 may determine the one or more potential actions to be performed in response to the user input data 102. If the system 100 determines that the one or more actions are included in the set of actions previously authorized by the user 405, the system 100 may not ask for further authorization prior to causing the one or more potential actions to be performed.

For further example, in an instance where the response language model 720 generates the model output natural language data 125 including a request for additional information (in response to the response language model 720 determining that none of the potential responses are responsive to the user input and/or an ambiguity exists with respect to the user input and/or one or more of the tasks), which may be determined by the output routing component 740 based on, for example, the model output natural language data 125 including a question, the output routing component 740 may parse the model output natural language data 125 to determine whether the request for additional information is to be sent to the personalized context component 465 and/or output to the user 405. In some embodiments, the response language model 720 may include in the model output natural language data 125 an indication of whether the request for additional information should be sent to the personalized context component 465 and/or output to the user 405. In some embodiments, unless otherwise indicated in the model output natural language data 125, the output routing component 740 may determine to send the request for additional information to the personalized context component 465 prior to outputting the request for additional information to the user 405. In the instance where the personalized context component 465 is unable to resolve the ambiguity (or a component of the system 100 is unable to resolve the ambiguity using the personalized context data generated by the personalized context component 465), the output routing component 740 may determine the request for additional information is to be output to the user 405.

In some embodiments, the response arbitration component 460 may be configured to further process data representing a potential response to the user input that is generated by one or more other components of the system 100 not included in the LLM orchestrator component 430.

For example, the response arbitration component 460 may further receive data from an orchestrator component 830 (discussed in detail herein below with respect to FIG. 8) representing a potential response to the user input (e.g., the output of the skill component 654), where the orchestration of the processing performed to generate the potential response was performed by the orchestrator component 830, rather than the LLM orchestrator component 430. In such embodiments, the response arbitration component 460 may be further configured to arbitrate between first potential responses received as a result of the processing of the LLM orchestrator component 430 and second potential responses received as a result of the processing of the orchestrator component 830. As discussed above, the response arbitration component 460 may select one or more portions (e.g., potential actions, potential responses, etc.) of the first potential responses and/or the second potential responses that are determined to be responsive to the user input and cause output of the one or more portions (or a summarized representation of the one or more portions) and/or performance of the potential actions corresponding to the selected responses.

In some embodiments, the data received from the orchestrator component 830 may be included in the potential response data 443a-n. For example, the orchestrator component 830 may be determined to be configured to perform a function (e.g., cause other component(s) to perform a function) potentially relevant to the user input such that the LLM shortlister component 440 may cause the orchestrator component 830 to generate potential responses potentially responsive to the user input, which may be included in the potential response data 443a-n sent to the response arbitration component 460.

In some embodiments, the language models 520, 540, 640, 720 may be fine-tuned to perform a particular task(s). Fine-tuning of the language models 520, 540, 640, 720 may be performed using one or more techniques. One example fine-tuning technique is transfer learning that involves reusing a pre-trained model's weights and architecture for a new task. The pre-trained model may be trained on a large, general dataset, and the transfer learning approach allows for efficient and effective adaptation to specific tasks. Another example fine-tuning technique is sequential fine-tuning where a pre-trained model is fine-tuned on multiple related tasks sequentially. This allows the model to learn more nuanced and complex language patterns across different tasks, leading to better generalization and performance. Yet another fine-tuning technique is task-specific fine-tuning where the pre-trained model is fine-tuned on a specific task using a task-specific dataset. Yet another fine-tuning technique is multi-task learning where the pre-trained model is fine-tuned on multiple tasks simultaneously. This approach enables the model to learn and leverage the shared representations across different tasks, leading to better generalization and performance. Yet another fine-tuning technique is adapter training that involves training lightweight modules that are plugged into the pre-trained model, allowing for fine-tuning on a specific task without affecting the original model's performance on other tasks.

In some embodiments, one or more components of the system 100 discussed herein above may be configured to begin processing with respect to data as soon as the data or a portion of the data is available to the one or more components. Some components of the system 100 are generative components/models that can begin processing with respect to portions of data as they are available, instead of waiting to initiate processing after the entirety of data is available. In other words, the system 100 may be configured to stream portions of data associated with processing with respect to a user input to the one or more components such that the one or more components may begin performing their configured processing with respect to that data as soon as it is available to the one or more components. For example, if the output of the plan generation language model 520, the task selection language model 540, and/or the shortlister language model 640 indicates that additional information is needed to complete a first task associated with a user input, a request for the additional information may be sent to the personalized context component 465. Thereafter, the plan generation language model 520, the task selection language model 540, and/or the shortlister language model 640 may continue to process to complete their configured operations. For example, while the personalized context component 465 is processing to determine the additional information, the system 100 may begin processing with respect to a second task associated with the user input. Thereafter, the output of the personalized context component 465 may be sent to the response arbitration component 460 such that once the response arbitration component 460 receives the output of the LLM shortlister component 440, the response arbitration component 460 may resolve the ambiguity that resulted in the request for additional information in order to generate the model output natural language data 125. For further example, if the user input data 102 is generated to include the natural language representation of the user input, but the processing required to determine the corresponding contextual signals (e.g., weather data, time of data, dialog history, device information, etc.) is yet to be completed, the plan generation component 435 may begin processing with respect to the natural language representation of the user input. Once the corresponding contextual signals have been generated, the plan generation component 435 may begin processing with respect to the contextual signals and may update downstream components with the result of the processing with respect to the contextual signals.

As another example, if the plan generation component 435 determines that more than one task is to be completed to perform an action responsive to a user input, and the LLM shortlister component 440 processes as described herein above to cause one or more components to generate potential responses with respect to a first task of the more than one tasks, the LLM shortlister component 440 may send the potential responses (and a representation of the user input and the current task) to the response arbitration component 460 to process as described herein above with respect to those potential responses while the system 100 (e.g., the plan generation component 435 and/or the LLM shortlister component 440) completes processing with respect to the remaining tasks of the one or more tasks. Therefore, the response arbitration component 460 may process as described herein to select between the potential responses associated with the first task while the potential responses associated with one or more of the remaining tasks is completed. As such, the response arbitration component 460 may only need to arbitrate between the potential responses associated with the first task that were previously selected by the response arbitration component 460 as being responsive to the first task when the response arbitration component 460 later processes with respect to further potential responses associated with further tasks.

As a further example, if the API shortlister component 620 determines (e.g., with a confidence value that meets or exceeds a particular threshold) that a particular API or API description should be included in the relevant API data, the API shortlister component 620 may provide the corresponding relevant API data to the shortlister prompt generation component 610 so that the shortlister prompt generation component 610 may begin processing with respect to the relevant API data while the API shortlister component 620 continues to determine one or more further relevant API data. In general, the system 100 is capable of performing such streaming and processing of portions of data discussed herein (e.g., for processing with respect to a user input) and updating downstream components with the results of processing of newly available portions of data as the data becomes available for processing.

The system 100 may operate using various components as described in FIG. 8. The various components may be located on same or different physical devices. Communication between various components may occur directly or across a network(s) 499. The user device 410 may include audio capture component(s), such as a microphone or array of microphones of a user device 410, captures audio 810 and creates corresponding audio data. Once speech is detected in audio data representing the audio 810, the user device 410 may determine if the speech is directed at the user device 410/system component(s). In at least some embodiments, such determination may be made using a wakeword detection component 820. The wakeword detection component 820 may be configured to detect various wakewords. In at least some examples, each wakeword may correspond to a name of a different digital assistant. An example wakeword/digital assistant name is “Alexa.” In another example, input to the system may be in form of text data 813, for example as a result of a user typing an input into a user interface of user device 410. Other input forms may include indication that the user has pressed a physical or virtual button on user device 410, the user has made a gesture, etc. The user device 410 may also capture images using camera(s) of the user device 410 and may send image data 821 representing those image(s) to the system component(s). The image data 821 may include raw image data or image data processed by the user device 410 before sending to the system component(s). The image data 821 may be used in various manners by different components of the system to perform operations such as determining whether a user is directing an utterance to the system, interpreting a user command, responding to a user command, etc.

The wakeword detection component 820 of the user device 410 may process the audio data, representing the audio 810, to determine whether speech is represented therein. The user device 410 may use various techniques to determine whether the audio data includes speech. In some examples, the user device 410 may apply voice-activity detection (VAD) techniques. Such techniques may determine whether speech is present in audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the user device 410 may implement a classifier configured to distinguish speech from background noise. The classifier may be implemented by techniques such as linear classifiers, support vector machines, and decision trees. In still other examples, the user device 410 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

Wakeword detection is typically performed without performing linguistic analysis, textual analysis, or semantic analysis. Instead, the audio data, representing the audio 810, is analyzed to determine if specific characteristics of the audio data match preconfigured acoustic waveforms, audio signatures, or other data corresponding to a wakeword.

Thus, the wakeword detection component 820 may compare audio data to stored data to detect a wakeword. One approach for wakeword detection applies general large vocabulary continuous speech recognition (LVCSR) systems to decode audio signals, with wakeword searching being conducted in the resulting lattices or confusion networks. Another approach for wakeword detection builds HMMs for each wakeword and non-wakeword speech signals, respectively. The non-wakeword speech includes other spoken words, background noise, etc. There can be one or more HMMs built to model the non-wakeword speech characteristics, which are named filler models. Viterbi decoding is used to search the best path in the decoding graph, and the decoding output is further processed to make the decision on wakeword presence. This approach can be extended to include discriminative information by incorporating a hybrid DNN-HMM decoding framework. In another example, the wakeword detection component 820 may be built on deep neural network (DNN)/recursive neural network (RNN) structures directly, without HMM being involved. Such an architecture may estimate the posteriors of wakewords with context data, either by stacking frames within a context window for DNN, or using RNN. Follow-on posterior threshold tuning or smoothing is applied for decision making. Other techniques for wakeword detection, such as those known in the art, may also be used.

Once the wakeword is detected by the wakeword detection component 820 and/or input is detected by an input detector, the user device 410 may “wake” and begin transmitting audio data 811, representing the audio 810, to the system component(s) 420. The audio data 811 may include data corresponding to the wakeword; in other embodiments, the portion of the audio corresponding to the wakeword is removed by the user device 410 prior to sending the audio data 811 to the system component(s) 420. In the case of touch input detection or gesture-based input detection, the audio data may not include a wakeword.

In some implementations, the system 100 may include more than one system component(s). The system component(s) 420 may respond to different wakewords and/or perform different categories of tasks. Each system component(s) may be associated with its own wakeword such that speaking a certain wakeword results in audio data be sent to and processed by a particular system. For example, detection of the wakeword “Alexa” by the wakeword detection component 820 may result in sending audio data to system component(s) 420 for processing while detection of the wakeword “Computer” by the wakeword detector may result in sending audio data to system component(s)b for processing. The system may have a separate wakeword and system for different skills/systems (e.g., “Dungeon Master” for a game play skill/system component(s)c) and/or such skills/systems may be coordinated by one or more skill component(s) 654 of one or more system component(s) 420.

The user device 410 and the system component(s) 420 may also include a system directed input detector 885. The system directed input detector 885 may be configured to determine whether an input to the system (for example speech, a gesture, etc.) is directed to the system or not directed to the system (for example directed to another user, etc.). The system directed input detector 885 may work in conjunction with the wakeword detection component 820. If the system directed input detector 885 determines an input is directed to the system, the user device 410 may “wake” and begin sending captured data for further processing. If data is being processed the user device 410 may indicate such to the user, for example by activating or changing the color of an illuminated output (such as a light emitting diode (LED) ring), displaying an indicator on a display (such as a light bar across the display), outputting an audio indicator (such as a beep) or otherwise informing a user that input data is being processed. If the system directed input detector 885 determines an input is not directed to the system (such as a speech or gesture directed to another user) the user device 410 may discard the data and take no further action for processing purposes. In this way the system 100 may prevent processing of data not directed to the system, thus protecting user privacy. As an indicator to the user, however, the system may output an audio, visual, or other indicator when the system directed input detector 885 is determining whether an input is potentially device directed. For example, the system may output an orange indicator while considering an input, and may output a green indicator if a system directed input is detected. Other such configurations are possible.

Upon receipt by the system component(s) 420, the audio data 811 may be sent to an orchestrator component 830 and/or the LLM orchestrator component 430. The orchestrator component 830 may include memory and logic that enables the orchestrator component 830 to transmit various pieces and forms of data to various components of the system, as well as perform other operations as described herein. In some embodiments, the orchestrator component 830 may optionally be included in the system component(s) 420. In embodiments where the orchestrator component 830 is not included in the system component(s) 420, the audio data 811 may be sent directly to the LLM orchestrator component 430. Further, in such embodiments, each of the components of the system component(s) 420 may be configured to interact with the LLM orchestrator component 430, the action plan execution component 445, and/or the API provider component 650.

In some embodiments, the system component(s) 420 may include an arbitrator component 882, which may be configured to determine whether the orchestrator component 830 and/or the LLM orchestrator component 430 are to process with respect to the audio data 811. In some embodiments, the LLM orchestrator component 430 may be selected to process with respect to the audio data 811 only if the user 405 associated with the audio data 811 (or the user device 410 that captured the audio 810) has previously indicated that the LLM orchestrator component 430 may be selected to process with respect to user inputs received from the user 405.

In some embodiments, the arbitrator component 882 may determine the orchestrator component 830 and/or the LLM orchestrator component 430 are to process with respect to the audio data 811 based on metadata associated with the audio data 811. For example, the arbitrator component 882 may be a classifier configured to process a natural language representation of the audio data 811 (e.g., output by the ASR component 850) and classify the corresponding user input as to be processed by the orchestrator component 830 and/or the LLM orchestrator component 430. For further example, the arbitrator component 882 may determine whether the device from which the audio data 811 is received is associated with an indicator representing the audio data 811 is to be processed by the orchestrator component 830 and/or the LLM orchestrator component 430. As an even further example, the arbitrator component 882 may determine whether the user (e.g., determined using data output from the user recognition component 895) from which the audio data 811 is received is associated with a user profile including an indicator representing the audio data 811 is to be processed by the orchestrator component 830 and/or the LLM orchestrator component 430. As another example, the arbitrator component 882 may determine whether the audio data 811 (or the output of the ASR component 850) corresponds to a request representing that the audio data 811 is to be processed by the orchestrator component 830 and/or the LLM orchestrator component 430 (e.g., a request including “let's chat” may represent that the audio data 811 is to be processed by the LLM orchestrator component 430).

In some embodiments, if the arbitrator component 882 is unsure (e.g., a confidence score corresponding to whether the orchestrator component 830 and/or the LLM orchestrator component 430 is to process is below a threshold), then the arbitrator component 882 may send the audio data 811 to both of the orchestrator component 830 and the LLM orchestrator component 430. In such embodiments, the orchestrator component 830 and/or the LLM orchestrator component 430 may include further logic for determining further confidence scores during processing representing whether the orchestrator component 830 and/or the LLM orchestrator component 430 should continue processing, as is discussed further herein below.

The arbitrator component 882 may send the audio data 811 to an ASR component 850. In some embodiments, the component selected to process the audio data 811 (e.g., the orchestrator component 830 and/or the LLM orchestrator component 430) may send the audio data 811 to the ASR component 850. The ASR component 850 may transcribe the audio data 811 into text data. The text data output by the ASR component 850 represents one or more than one (e.g., in the form of an N-best list) ASR hypotheses representing speech represented in the audio data 811. The ASR component 850 interprets the speech in the audio data 811 based on a similarity between the audio data 811 and pre-established language models. For example, the ASR component 850 may compare the audio data 811 with models for sounds (e.g., acoustic units such as phonemes, senons, phones, etc.) and sequences of sounds to identify words that match the sequence of sounds of the speech represented in the audio data 811. The ASR component 850 sends the text data generated thereby to the arbitrator component 882, the orchestrator component 830, and/or the LLM orchestrator component 430. In instances where the text data is sent to the arbitrator component 882, the arbitrator component 882 may send the text data to the component selected to process the audio data 811 (e.g., the orchestrator component 830 and/or the LLM orchestrator component 430). The text data sent from the ASR component 850 to the arbitrator component 882, the orchestrator component 830, and/or the LLM orchestrator component 430 may include a single top-scoring ASR hypothesis or may include an N-best list including multiple top-scoring ASR hypotheses. An N-best list may additionally include a respective score associated with each ASR hypothesis represented therein.

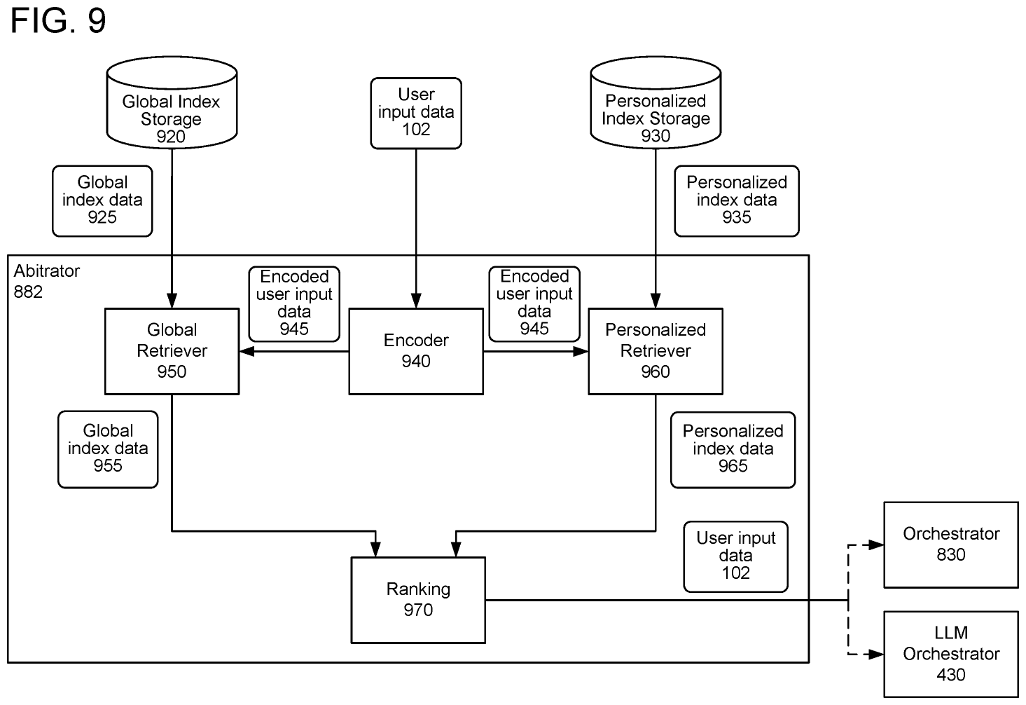

FIG. 9 illustrates example components and processing of the arbitrator component 882. As shown in FIG. 9, the arbitrator component 882 may include an encoder component 940, a global retriever component 950, a personalized retriever component 960, and a ranking component 970. The arbitrator component 882 may be in communication with a global index storage 920 and a personalized index storage 930. The arbitrator component 882 may be configured to perform retrieval-based techniques based on a semantic vectorized representation of a user input and historical user inputs received by the system 100 over a period of time (e.g., past 30 days) to determine whether the orchestrator component 830 or the LLM orchestrator component 430 or both of them should process with respect to the user input.

The user input data 102 may be received at the encoder component 940 of the arbitrator component 882. The encoder component 940 may process the user input data 102 to generate encoded user input data 945 represented an encoded representation of the user input data 102 (e.g., a vectorized representation of the user input). The encoder component may send the encoded user input data 945 to the global retriever component 950 and the personalized retriever component 960. In some embodiments, the encoder component 940 may be trained using techniques associated with Deep Structured Semantic Models (DSSM).

The global retriever component 950 is configured to determine one or more historical user inputs that are similar to the user input data 102. The global retriever component 950 queries a global index storage 920 for global index data 925 representing one or more historical user inputs that are semantically similar to the user input data 102. The global retriever component 950 may include one or more historical user inputs received from various users over a period of time (e.g., 30 days). In some embodiments, the global index data 925 may correspond to an encoded representation(s) of the historical user input(s). In such embodiments, the one or more historical user inputs that are semantically similar to the user input data 102 may be determined based on comparing the encoded user input data 945 to the encoder representation(s) of the historical user input(s) (e.g., to determine a cosine similarity). The global retriever component 950 may send the global index data 925 to the ranking component 970.

The personalized retriever component 960 is configured to determine one or more historical user inputs that are similar to the user input data 102, where the one or more historical user inputs are associated with the user 405 that provided the user input corresponding to the user input data 102. The personalized retriever component 960 queries a personalized index storage 930 for personalized index data 935 representing one or more historical user inputs that are semantically similar to the user input data 102 and were provided by the same user that provided the user input corresponding to the user input data 102. The personalized retriever component 960 may include one or more historical user inputs received from the user corresponding to the user input data 102 over a period of time (e.g., 30 days). In some embodiments, the personalized index data 935 may correspond to an encoded representation(s) of the historical user input(s). In such embodiments, the one or more historical user inputs that are semantically similar to the user input data 102 may be determined based on comparing the encoded user input data 945 to the encoder representation(s) of the historical user input(s) (e.g., to determine a cosine similarity). The personalized retriever component 960 may send the personalized index data 935 to the ranking component 970.

In some embodiments, the global index storage 920 and/or the personalized index storage 930 may further include metadata associated with the historical user inputs, which may be further included in the global index data 925 and/or the personalized index data 935. For example, the global index storage 920 and/or the personalized index storage 930 may further include a user satisfaction associated with a system-generated response to the user input, a value representing how many times the user input was received during the time period, a domain (e.g., routine, smart home, shopping, weather, etc.), etc.

In some embodiments, the global retriever component 950 and/or the personalized retriever component 960 may retrieve the global index data 925 and/or the personalized index data 935 semantically similar to the encoded user input data 945 using Maximum Inner Product Search Solution.

The ranking component 970 may process the global index data 955 and the personalized index data 965 to determine whether to send the user input data 102 to the orchestrator component 830 and/or the LLM orchestrator component 430. In some embodiments, the ranking component 970 may make such a determination based on the metadata included in the global index data 955 and/or the personalized index data 965. In some embodiments, the ranking component 970 may be a rule-based component. In other embodiments, the ranking component 970 may be an ML-based component (e.g., a decision tree, a classifier, an LLM, etc.). In embodiments where the ranking component 970 is an LLM, the ranking component 970 may be further configured to determine if there the user input is ambiguous, in which case the ranking component 970 may generate a request for additional information to resolve the ambiguity.

In some embodiments, after determining that the orchestrator component 830 and/or the LLM orchestrator component 430 should process with respect to the user input data 102, the ranking component 970 may be configured to periodically determine whether the orchestrator component 830 and/or the LLM orchestrator component 430 should continue processing with respect to the user input data 102. For example, after a particular point in the processing of the orchestrator component 830 (e.g., after performing NLU, prior to determining a skill component 654 to process with respect to the user input data 102, prior to performing an action responsive to the user input, etc.) and/or the LLM orchestrator component 430 (e.g., after selecting a task to be completed, after receiving the action response data from the one or more components, after completing a task, prior to performing an action responsive to the user input, etc.) the orchestrator component 830 and/or the LLM orchestrator component 430 may query the arbitrator component 882 has determined that the orchestrator component 830 and/or the LLM orchestrator component 430 should halt processing with respect to the user input data 102. As discussed above, the system 100 may be configured to stream portions of data associated with processing with respect to a user input to the one or more components such that the one or more components may begin performing their configured processing with respect to that data as soon as it is available to the one or more components. As such, the arbitrator component 882 may cause the orchestrator component 830 and/or the LLM orchestrator component 430 to begin processing with respect to a user input as soon as a portion of data associated with the user input data 102 is available (e.g., the ASR data, context data, output of the user recognition component 895. Thereafter, once the arbitrator component 882 has enough data to perform the processing described herein above to determine whether the orchestrator component 830 and/or the LLM orchestrator component 430 is to process with respect to the user input, the arbitrator component 882 may inform the corresponding component (e.g., the orchestrator component 830 and/or the LLM orchestrator component 430) to continue/halt processing with respect to the user input at one of the logical checkpoints in the processing of the orchestrator component 830 and/or the LLM orchestrator component 430.

In some embodiments, the orchestrator component 830 and/or the LLM orchestrator component 430 may periodically confirm that they are to continue processing with respect to the user input. For example, the arbitrator component 882 may be further configured to periodically receive data generated by the orchestrator component 830 and/or the LLM orchestrator component 430 during processing with respect to the user input and determine whether the orchestrator component 830 and/or the LLM orchestrator component 430 should continue processing. The arbitrator component 882 may receive such data at logical checkpoints in the processing of the orchestrator component 830 (e.g., after completion of ASR processing, after completion of natural language understanding processing, after selection of a skill component to process with respect to the user input and prior to initiation of processing by the skill component, or prior to the processing of any component discussed herein with respect to the orchestrator component 830.) and/or the LLM orchestrator component 430 (e.g., prior to processing of the LLM shortlister component 440, prior to beginning processing with respect to a subsequent task, or prior to the processing of any other component discussed herein above with respect to the LLM orchestrator component 430). The arbitrator component 882 may be configured to process as described herein above to compare the received data to data associated with processing of a previous user input. This may allow the arbitrator component 882 to make a more informed determination (e.g., based on the additional data determined during processing of the orchestrator component 830 and/or the LLM orchestrator component 430) as to which component(s) should process the user input. In some embodiments, the data may be received at another component of the system 100 configured to process as described herein.

In some embodiments, after sending the data to the arbitrator component 882, the orchestrator component 830 and/or the LLM orchestrator component 430 may temporarily suspend processing with respect to the user input until they receive data from the arbitrator component 882 confirming that they are to continue processing with respect to the user input. As discussed above, in some embodiments, the LLM orchestrator component 430 may send the data to the arbitrator component 882 prior to the processing of the LLM shortlister component 440. In some embodiments, the LLM orchestrator component 430 may further include a component configured to process the task processing data output by the plan generation component 435 (e.g., the task data 437) to determine whether completion of the current task will result in a real-world action (e.g., a change in the state of a device, such as turning on a light, changing a channel on a television, changing a temperature value on a thermostat, locking a door, etc.). If the component determines that completion of the current task will result in a real-world action, then the LLM orchestrator component 430 may temporarily suspend its processing prior to the processing of the LLM shortlister component 440. If the component determines that completion of the current task will not result in a real-world action, then the LLM orchestrator component 430 may begin processing of the LLM shortlister component 440, rather than temporarily suspending processing. In some embodiments, the orchestrator component 830 may include a similarly configured component.

A skill system component(s) 425 may communicate with a skill component(s) 654 within the system component(s) 420 directly with the orchestrator component 830 and/or the action plan execution component 445, or with other components. A skill system component(s) 425 may be configured to perform one or more actions. An ability to perform such action(s) may sometimes be referred to as a “skill.” That is, a skill may enable a skill system component(s) 425 to execute specific functionality in order to provide data or perform some other action requested by a user. For example, a weather service skill may enable a skill system component(s) 425 to provide weather information to the system component(s) 420, a car service skill may enable a skill system component(s) 425 to book a trip with respect to a taxi or ride sharing service, an order pizza skill may enable a skill system component(s) 425 to order a pizza with respect to a restaurant's online ordering system, etc. Additional types of skills include home automation skills (e.g., skills that enable a user to control home devices such as lights, door locks, cameras, thermostats, etc.), entertainment device skills (e.g., skills that enable a user to control entertainment devices such as smart televisions), video skills, flash briefing skills, as well as custom skills that are not associated with any pre-configured type of skill.

The system component(s) 420 may be configured with a skill component 654 dedicated to interacting with the skill system component(s) 425. Unless expressly stated otherwise, reference to a skill, skill device, or skill component may include a skill component 654 operated by the system component(s) 420 and/or skill operated by the skill system component(s) 425. Moreover, the functionality described herein as a skill or skill may be referred to using many different terms, such as an action, bot, app, or the like. The skill component 654 and or skill system component(s) 425 may return output data to the orchestrator component 830.

Dialog processing is a field of computer science that involves communication between a computing system and a human via text, audio, and/or other forms of communication. While some dialog processing involves only simple generation of a response given only a most recent input from a user (i.e., single-turn dialog), more complicated dialog processing involves determining and optionally acting on one or more goals expressed by the user over multiple turns of dialog, such as making a restaurant reservation and/or booking an airline ticket. These multi-turn “goal-oriented” dialog systems typically need to recognize, retain, and use information collected during more than one input during a back-and-forth or “multi-turn” interaction with the user.

The system component(s) includes a TTS component 380. The TTS component 380 may generate audio data (e.g., synthesized speech) from text data using one or more different methods. Text data input to the TTS component 380 may come from a skill component 654, the orchestrator component 830, or another component of the system. In one method of synthesis called unit selection, the TTS component 380 matches text data against a database of recorded speech. The TTS component 380 selects matching units of recorded speech and concatenates the units together to form audio data. In another method of synthesis called parametric synthesis, the TTS component 380 varies parameters such as frequency, volume, and noise to create audio data including an artificial speech waveform. Parametric synthesis uses a computerized voice generator, sometimes called a vocoder.

The user device 410 may include still image and/or video capture components such as a camera or cameras to capture one or more images. The user device 410 may include circuitry for digitizing the images and/or video for transmission to the system component(s) 420 as image data. The user device 410 may further include circuitry for voice command-based control of the camera, allowing a user 405 to request capture of image or video data. The user device 410 may process the commands locally or send audio data 811 representing the commands to the system component(s) 420 for processing, after which the system component(s) 420 may return output data that can cause the user device 410 to engage its camera.

The system component(s) 420 may include a user recognition component 895 that recognizes one or more users using a variety of data. However, the disclosure is not limited thereto, and the user device 410 may include a user recognition component XXE95 instead of and/or in addition to user recognition component 895 of the system component(s) 420 without departing from the disclosure. User recognition component XXE95 operates similarly to user recognition component 895.

The user recognition component 895 may take as input the audio data 811 and/or text data output by the ASR component 850. The user recognition component 895 may perform user recognition by comparing audio characteristics in the audio data 811 to stored audio characteristics of users. The user recognition component 895 may also perform user recognition by comparing biometric data (e.g., fingerprint data, iris data, etc.), received by the system in correlation with the present user input, to stored biometric data of users assuming user permission and previous authorization. The user recognition component 895 may further perform user recognition by comparing image data (e.g., including a representation of at least a feature of a user), received by the system in correlation with the present user input, with stored image data including representations of features of different users. The user recognition component 895 may perform additional user recognition processes, including those known in the art.

The user recognition component 895 determines scores indicating whether user input originated from a particular user. For example, a first score may indicate a likelihood that the user input originated from a first user, a second score may indicate a likelihood that the user input originated from a second user, etc. The user recognition component 895 also determines an overall confidence regarding the accuracy of user recognition operations.

Output of the user recognition component 895 may include a single user identifier corresponding to the most likely user that originated the user input. Alternatively, output of the user recognition component 895 may include an N-best list of user identifiers with respective scores indicating likelihoods of respective users originating the user input. The output of the user recognition component 895 may be used to inform processing of the arbitrator component 882, the orchestrator component 830, and/or the LLM orchestrator component 430 as well as processing performed by other components of the system.

The system component(s) 420/user device 410 may include a presence detection component that determines the presence and/or location of one or more users using a variety of data.

The system 100 (either on user device 410, system component(s), or a combination thereof) may include profile storage for storing a variety of information related to individual users, groups of users, devices, etc. that interact with the system. As used herein, a “profile” refers to a set of data associated with a user, group of users, device, etc. The data of a profile may include preferences specific to the user, device, etc.; input and output capabilities of the device; internet connectivity information; user bibliographic information; subscription information, as well as other information.

The profile storage 870 may include one or more user profiles, with each user profile being associated with a different user identifier/user profile identifier. Each user profile may include various user identifying data. Each user profile may also include data corresponding to preferences of the user. Each user profile may also include preferences of the user and/or one or more device identifiers, representing one or more devices of the user. For instance, the user account may include one or more IP addresses, MAC addresses, and/or device identifiers, such as a serial number, of each additional electronic device associated with the identified user account. When a user logs into to an application installed on a user device 410, the user profile (associated with the presented login information) may be updated to include information about the user device 410, for example with an indication that the device is currently in use. Each user profile may include identifiers of skills that the user has enabled. When a user enables a skill, the user is providing the system component(s) with permission to allow the skill to execute with respect to the user's natural language user inputs. If a user does not enable a skill, the system component(s) may not invoke the skill to execute with respect to the user's natural language user inputs.

The profile storage 870 may include one or more group profiles. Each group profile may be associated with a different group identifier. A group profile may be specific to a group of users. That is, a group profile may be associated with two or more individual user profiles. For example, a group profile may be a household profile that is associated with user profiles associated with multiple users of a single household. A group profile may include preferences shared by all the user profiles associated therewith. Each user profile associated with a group profile may additionally include preferences specific to the user associated therewith. That is, each user profile may include preferences unique from one or more other user profiles associated with the same group profile. A user profile may be a stand-alone profile or may be associated with a group profile.

The profile storage 870 may include one or more device profiles. Each device profile may be associated with a different device identifier. Each device profile may include various device identifying information. Each device profile may also include one or more user identifiers, representing one or more users associated with the device. For example, a household device's profile may include the user identifiers of users of the household.

Although the components of FIG. 8 may be illustrated as part of system component(s) 420, user device 410, or otherwise, the components may be arranged in other device(s) (such as in user device 410 if illustrated in system component(s) 420 or vice-versa, or in other device(s) altogether) without departing from the disclosure. XXE illustrates such a configured user device 410.

In at least some embodiments, the system component(s) may receive the audio data 811 from the user device 410, to recognize speech corresponding to a spoken input in the received audio data 811, and to perform functions in response to the recognized speech. In at least some embodiments, these functions involve sending directives (e.g., commands), from the system component(s) to the user device 410 (and/or other devices 410) to cause the user device 410 to perform an action, such as output an audible response to the spoken input via a loudspeaker(s), and/or control secondary devices in the environment by sending a control command to the secondary devices.

Thus, when the user device 410 is able to communicate with the system component(s) over the network(s) 499, some or all of the functions capable of being performed by the system component(s) may be performed by sending one or more directives over the network(s) 499 to the user device 410, which, in turn, may process the directive(s) and perform one or more corresponding actions. For example, the system component(s), using a remote directive that is included in response data (e.g., a remote response), may instruct the user device 410 to output an audible response (e.g., using TTS processing performed by an on-device TTS component) to a user's question via a loudspeaker(s) of (or otherwise associated with) the user device 410, to output content (e.g., music) via the loudspeaker(s) of (or otherwise associated with) the user device 410, to display content on a display of (or otherwise associated with) the user device 410, and/or to send a directive to a secondary device (e.g., a directive to turn on a smart light). It is to be appreciated that the system component(s) may be configured to provide other functions in addition to those discussed herein, such as, without limitation, providing step-by-step directions for navigating from an origin location to a destination location, conducting an electronic commerce transaction on behalf of the user 405 as part of a shopping function, establishing a communication session (e.g., a video call) between the user 405 and another user, and so on.

As noted with respect to FIG. 8, the user device 410 may include a wakeword detection component 820 configured to compare the audio data 811 to stored models used to detect a wakeword (e.g., “Alexa”) that indicates to the user device 410 that the audio data 811 is to be processed by the user device 410 (e.g., by an on-device orchestrator component and/or LLM orchestrator, which are configured similar to the orchestrator component 830 and the LLM orchestrator component 430, respectively). In at least some embodiments, a hybrid selector, of the user device 410, may send the audio data 811 to the wakeword detection component 820. If the wakeword detection component 820 detects a wakeword in the audio data 811, the wakeword detection component 820 may send an indication of such detection to the hybrid selector. In response to receiving the indication, the hybrid selector may send the audio data 811 to the system component(s) and/or an ASR component. The wakeword detection component 820 may also send an indication, to the hybrid selector, representing a wakeword was not detected. In response to receiving such an indication, the hybrid selector may refrain from sending the audio data 811 to the system component(s), and may prevent the ASR component from further processing the audio data 811. In this situation, the audio data 811 can be discarded.

The user device 410 may conduct its own speech processing using on-device language processing components, such as an ASR component, similar to the manner discussed herein with respect to the ASR component 850 of the system component(s). ASR component may operate similarly to ASR component 850. The user device 410 may also internally include, or otherwise have access to, other components such as one or more skill components capable of executing commands based on the output of the orchestrator component, the LLM orchestrator, or other results determined by the user device 410/system component(s) (which may operate similarly to skill components 654), an arbitrator component (configured to process in a similar manner to that discussed herein above with respect to the arbitrator component 882), an action plan execution component (configured to process in a similar manner to that discussed herein with respect to the action plan execution component 445), a personalized context component (configured to process in a similar manner to that discussed herein with respect to the personalized context component 465) an API provider component (configured to process in a similar manner to that discussed herein with respect to the API provider component 650), and LLM agent component (configured to process in a similar manner to that discussed herein with respect to the LLM agent component 652), a user recognition component (configured to process in a similar manner to that discussed herein with respect to the user recognition component 895 of the system component(s)), profile storage (configured to store similar profile data to that discussed herein with respect to the profile storage 870 of the system component(s)), or other components. In at least some embodiments, the profile storage may only store profile data for a user or group of users specifically associated with the user device 410. Similar to as described above with respect to skill component 654, a skill component may communicate with a skill system component(s) 425. The user device 410 may also have its own TTS component, which may operate similarly to TTS component 380.

In at least some embodiments, the on-device language processing components may not have the same capabilities as the language processing components of the system component(s). For example, the on-device language processing components may be configured to handle only a subset of the natural language user inputs that may be handled by the system component(s). For example, such subset of natural language user inputs may correspond to local-type natural language user inputs, such as those controlling devices or components associated with a user's home. In such circumstances the on-device language processing components may be able to more quickly interpret and respond to a local-type natural language user input, for example, than processing that involves the system component(s). If the user device 410 attempts to process a natural language user input for which the on-device language processing components are not necessarily best suited, the language processing results determined by the user device 410 may indicate a low confidence or other metric indicating that the processing by the user device 410 may not be as accurate as the processing done by the system component(s).

The hybrid selector, of the user device 410, may include a hybrid proxy (HP) configured to proxy traffic to/from the system component(s). For example, the HP may be configured to send messages to/from a hybrid execution controller (HEC) of the hybrid selector. For example, command/directive data received from the system component(s) can be sent to the HEC using the HP. The HP may also be configured to allow the audio data 811 to pass to the system component(s) while also receiving (e.g., intercepting) this audio data 811 and sending the audio data 811 to the HEC.

In at least some embodiments, the hybrid selector may further include a local request orchestrator (LRO) configured to notify the ASR component of the user device 410 about the availability of new audio data 811 that represents user speech, and to otherwise initiate the operations of local language processing when new audio data 811 becomes available. In general, the hybrid selector may control execution of local language processing, such as by sending “execute” and “terminate” events/instructions. An “execute” event may instruct a component to continue any suspended execution (e.g., by instructing the component to execute on a previously-determined intent in order to determine a directive). Meanwhile, a “terminate” event may instruct a component to terminate further execution, such as when the user device 410 receives directive data from the system component(s) and chooses to use that remotely-determined directive data.

Thus, when the audio data 811 is received, the HP may allow the audio data 811 to pass through to the system component(s) and the HP may also input the audio data 811 to the on-device ASR component by routing the audio data 811 through the HEC of the hybrid selector, whereby the LRO notifies the ASR component of the audio data 811. At this point, the hybrid selector may wait for response data from either or both of the system component(s) or the local language processing components. However, the disclosure is not limited thereto, and in some examples the hybrid selector may send the audio data 811 only to the local ASR component without departing from the disclosure. For example, the user device 410 may process the audio data 811 locally without sending the audio data 811 to the system component(s).

The local ASR component is configured to receive the audio data 811 from the hybrid selector, and to recognize speech in the audio data 811. The user device 410 and/or the system component(s) may associate a unique identifier with each natural language user input. The user device 410 may include the unique identifier when sending the audio data 811 to the system component(s), and the response data from the system component(s) may include the unique identifier to identify which natural language user input the response data corresponds.

Various machine learning techniques may be used to train and operate models to perform various steps described herein, such as user recognition, sentiment detection, image processing, dialog management, etc. Models may be trained and operated according to various machine learning techniques. Such techniques may include, for example, neural networks (such as deep neural networks and/or recurrent neural networks), inference engines, trained classifiers, etc. Examples of trained classifiers include Support Vector Machines (SVMs), neural networks, decision trees, AdaBoost (short for “Adaptive Boosting”) combined with decision trees, and random forests. Focusing on SVM as an example, SVM is a supervised learning model with associated learning algorithms that analyze data and recognize patterns in the data, and which are commonly used for classification and regression analysis. Given a set of training examples, each marked as belonging to one of two categories, an SVM training algorithm builds a model that assigns new examples into one category or the other, making it a non-probabilistic binary linear classifier. More complex SVM models may be built with the training set identifying more than two categories, with the SVM determining which category is most similar to input data. An SVM model may be mapped so that the examples of the separate categories are divided by clear gaps. New examples are then mapped into that same space and predicted to belong to a category based on which side of the gaps they fall on. Classifiers may issue a “score” indicating which category the data most closely matches. The score may provide an indication of how closely the data matches the category.

In order to apply the machine learning techniques, the machine learning processes themselves need to be trained. Training a machine learning component such as, in this case, one of the first or second models, requires establishing a “ground truth” for the training examples. In machine learning, the term “ground truth” refers to the accuracy of a training set's classification for supervised learning techniques. Various techniques may be used to train the models including backpropagation, statistical learning, supervised learning, semi-supervised learning, stochastic learning, or other known techniques.

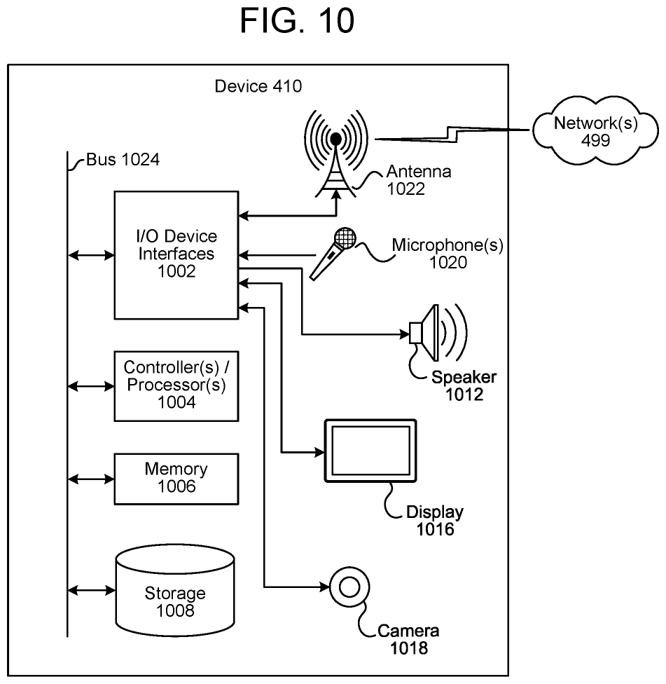

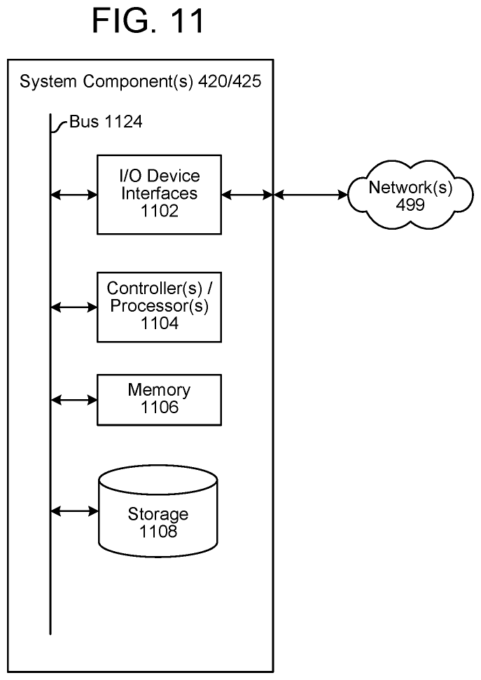

FIG. 10 is a block diagram conceptually illustrating a user device 410 that may be used with the system. FIG. 11 is a block diagram conceptually illustrating example components of a remote device, such as the natural language command processing system component(s), which may assist with ASR processing, NLU processing, etc., and a skill system component(s) 425. A system (420/425) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques.

While the user device 410 may operate locally to a user (e.g., within a same environment so the device may receive inputs and playback outputs for the user) the server/system component(s) may be located remotely from the user device 410 as its operations may not require proximity to the user. The server/system component(s) may be located in an entirely different location from the user device 410 (for example, as part of a cloud computing system or the like) or may be located in a same environment as the user device 410 but physically separated therefrom (for example a home server or similar device that resides in a user's home or business but perhaps in a closet, basement, attic, or the like). The system component(s) 420 may also be a version of a user device 410 that includes different (e.g., more) processing capabilities than other user device(s) 410 in a home/office. One benefit to the server/system component(s) being in a user's home/business is that data used to process a command/return a response may be kept within the user's home, thus reducing potential privacy concerns.

Multiple system components (420/425) may be included in the overall system 100 of the present disclosure, such as one or more natural language processing system component(s) 420 for performing ASR processing, one or more natural language processing system component(s) 420 for performing NLU processing, one or more skill system component(s) 425, etc. In operation, each of these systems may include computer-readable and computer-executable instructions that reside on the respective device (420/425), as will be discussed further below.

Each of these devices (410/420/425) may include one or more controllers/processors (1004/1104), which may each include a central processing unit (CPU) for processing data and computer-readable instructions, and a memory (1006/1106) for storing data and instructions of the respective device. The memories (1006/1106) may individually include volatile random access memory (RAM), non-volatile read only memory (ROM), non-volatile magnetoresistive memory (MRAM), and/or other types of memory. Each device (410/420/425) may also include a data storage component (1008/1108) for storing data and controller/processor-executable instructions. Each data storage component (1008/1108) may individually include one or more non-volatile storage types such as magnetic storage, optical storage, solid-state storage, etc. Each device (410/420/425) may also be connected to removable or external non-volatile memory and/or storage (such as a removable memory card, memory key drive, networked storage, etc.) through respective input/output device interfaces (1002/1102).

Computer instructions for operating each device (410/420/425) and its various components may be executed by the respective device's controller(s)/processor(s) (1004/1104), using the memory (1006/1106) as temporary “working” storage at runtime. A device's computer instructions may be stored in a non-transitory manner in non-volatile memory (1006/1106), storage (1008/1108), or an external device(s). Alternatively, some or all of the executable instructions may be embedded in hardware or firmware on the respective device in addition to or instead of software.

Each device (410/420/425) includes input/output device interfaces (1002/1102). A variety of components may be connected through the input/output device interfaces (1002/1102), as will be discussed further below. Additionally, each device (410/420/425) may include an address/data bus (1024/1124) for conveying data among components of the respective device. Each component within a device (410/420/425) may also be directly connected to other components in addition to (or instead of) being connected to other components across the bus (1024/1124).

Referring to FIG. 10, the user device 410 may include input/output device interfaces 1002 that connect to a variety of components such as an audio output component such as a speaker 1012, a wired headset or a wireless headset (not illustrated), or other component capable of outputting audio. The user device 410 may also include an audio capture component. The audio capture component may be, for example, a microphone 1020 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The user device 410 may additionally include a display 1016 for displaying content. The user device 410 may further include a camera 1018.

Via antenna(s) 1022, the input/output device interfaces 1002 may connect to one or more networks 499 via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 499, the system may be distributed across a networked environment. The I/O device interface (1002/1002) may also include communication components that allow data to be exchanged between devices such as different physical servers in a collection of servers or other components.

The components of the device(s) 410, the natural language command processing system component(s), or a skill system component(s) 425 may include their own dedicated processors, memory, and/or storage. Alternatively, one or more of the components of the device(s) 410, the natural language command processing system component(s), or a skill system component(s) 425 may utilize the I/O interfaces (1002/1102), processor(s) (1004/1104), memory (1006/1106), and/or storage (1008/1108) of the device(s) 410, natural language command processing system component(s), or the skill system component(s) 425, respectively. Thus, the ASR component 850 may have its own I/O interface(s), processor(s), memory, and/or storage; and so forth for the various components discussed herein.

As noted above, multiple devices may be employed in a single system. In such a multi-device system, each of the devices may include different components for performing different aspects of the system's processing. The multiple devices may include overlapping components. The components of the user device 410, the natural language command processing system component(s), and a skill system component(s) 425, as described herein, are illustrative, and may be located as a stand-alone device or may be included, in whole or in part, as a component of a larger device or system. As can be appreciated, a number of components may exist either on a system component(s) and/or on user device 410. Unless expressly noted otherwise, the system version of such components may operate similarly to the device version of such components and thus the description of one version (e.g., the system version or the local version) applies to the description of the other version (e.g., the local version or system version) and vice-versa.

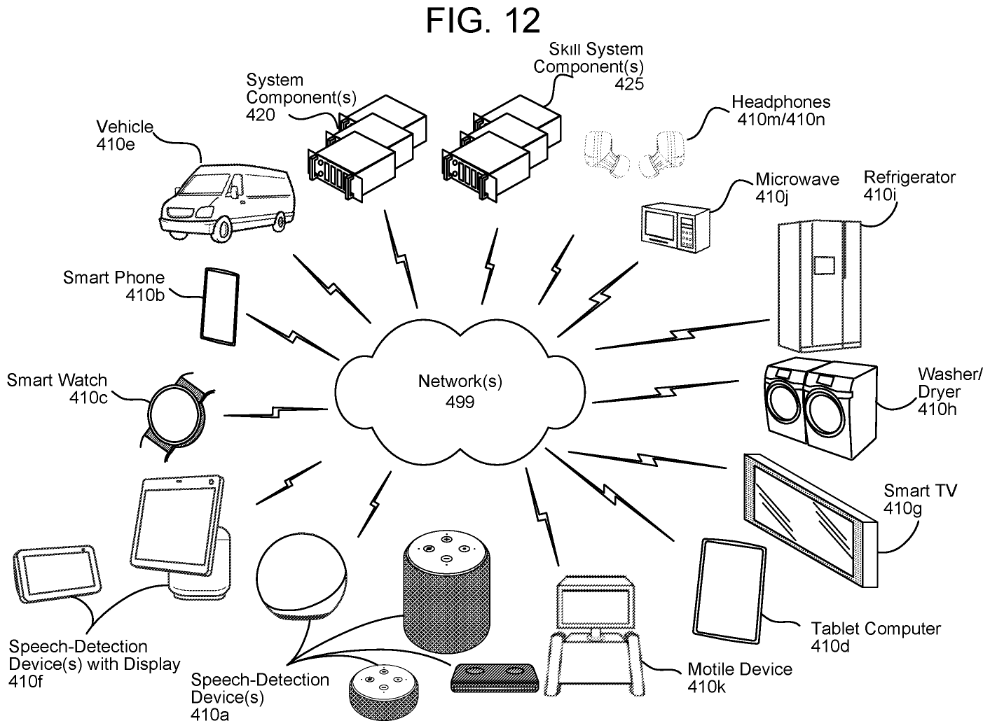

As illustrated in FIG. 12, multiple devices (410a-410n, 420, 425) may contain components of the system and the devices may be connected over a network(s) 499. The network(s) 499 may include a local or private network or may include a wide network such as the Internet. Devices may be connected to the network(s) 499 through either wired or wireless connections. For example, a speech-detection device 410a, a smart phone 410b, a smart watch 410c, a tablet computer 410d, a vehicle 410e, a speech-detection device with display 410f, a display/smart television 410g, a washer/dryer 410h, a refrigerator 410i, a microwave 410j, autonomously motile device 410k (e.g., a robot), etc., may be connected to the network(s) 499 through a wireless service provider, over a Wi-Fi or cellular network connection, or the like. Other devices are included as network-connected support devices, such as the natural language command processing system component(s) 420, the skill system component(s) 425, and/or others. The support devices may connect to the network(s) 499 through a wired connection or wireless connection. Networked devices may capture audio using one-or-more built-in or connected microphones or other audio capture devices, with processing performed by ASR components, NLU components, or other components of the same device or another device connected via the network(s) 499, such as the ASR component 850, etc. of the natural language command processing system component(s) 420.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein. Further, unless expressly stated to the contrary, features/operations/components, etc. from one embodiment discussed herein may be combined with features/operations/components, etc. from another embodiment discussed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method comprising:
receiving first input data representing a first natural language input;
receiving first context data associated with the first natural language input;
generating first prompt data including the first input data and the first context data, wherein the first prompt data represents a first request for a first language model to determine a first output responsive to the first natural language input;
processing, using a first set of layers of the first language model, the first prompt data to generate first natural language data responsive to the first natural language input, wherein the first set of layers are configured for natural language generation;
processing, using a second set of layers of the first language model, the first prompt data to generate first prosody data representing at least a first synthetic voice characteristic, wherein the second set of layers are configured for prosody prediction;
processing the first natural language data and the first prosody data to generate first output audio data representing first synthetic speech corresponding to the first synthetic voice characteristic and responsive to the first natural language input; and
causing presentation of the first output audio data.

2. The computer-implemented method of claim 1, wherein processing the first prompt data to generate the first prosody data comprises:
receiving, from a first layer of the first set of layers, first embedding data representing the first prompt data; and
processing, by the second set of layers, the first prompt data and the first embedding data to generate the first prosody data.

3. The computer-implemented method of claim 2, wherein the first embedding data is received at a second layer of the second set of layers, and the method further comprises:
processing, by the second layer of the second set of layers, the first prompt data and the first embedding data to generate second embedding data representing the first prompt data and the first embedding data; and
processing the second embedding data using a third layer of the second set of layers to generate third embedding data representing the first prompt data, wherein the first prosody data is generated based at least in part on the third embedding data.

4. The computer-implemented method of claim 1, wherein processing the first prompt data to generate the first natural language data comprises:
receiving, from a first layer of the second set of layers and at a second layer of the first set of layers, first embedding data representing the first prompt data, and
processing, by the first set of layers, the first prompt data and the first embedding data to generate the first natural language data.

5. A computer-implemented method comprising:
receiving first input data corresponding to a user input;
determining first prompt data including the first input data, wherein the first prompt data represents a first request for a first language model to determine an output responsive to the user input;
processing, using the first language model, the first prompt data to generate first natural language data responsive to the user input;
processing, using the first language model, the first prompt data to generate first prosody data representing at least a first voice characteristic;
using the first natural language data and the first prosody data to generate first output audio data representing first synthetic speech corresponding to the at least first voice characteristic; and
causing presentation of the first output audio data.

6. The computer-implemented method of claim 5, wherein:
processing the first prompt data to generate the first natural language data comprises processing, using a first set of layers of the first language model, the first prompt data, wherein the first set of layers are configured for natural language generation; and
processing the first prompt data to generate the first prosody data comprises processing, using a second set of layers of the first language model, the first prompt data, wherein the second set of layers are configured for prosody prediction.

7. The computer-implemented method of claim 6, wherein processing, using the second set of layers of the first language model, the first prompt data comprises:
receiving, from a first layer of the first set of layers and at a second layer of the second set of layers, first embedding data representing the first prompt data, wherein the first prosody data is generated based at least in part by processing the first embedding data.

8. The computer-implemented method of claim 6, wherein processing, using the first set of layers of the first language model, the first prompt data comprises:
receiving, from a first layer of the second set of layers and at a second layer of the first set of layers, first embedding data representing the first prompt data, and
processing, by the first set of layers, the first prompt data and the first embedding data to generate the first natural language data.

9. The computer-implemented method of claim 7, further comprising:
processing, by the second layer of the second set of layers, the first prompt data and the first embedding data to generate second embedding data representing the first prompt data and the first embedding data; and
processing the second embedding data using a third layer of the second set of layers to generate third embedding data representing the first prompt data, wherein the first prosody data is generated based at least in part on the third embedding data.

10. The computer-implemented method of claim 5, wherein the first prosody data corresponds to a spectrogram, and generating the first output audio data comprises:
processing, using a vocoder, the spectrogram.

11. The computer-implemented method of claim 5, wherein the first prosody data represents a natural language description of the at least first voice characteristic.

12. The computer-implemented method of claim 5, further comprising:
receiving context data associated with the user input, wherein the first prompt data represents a further instruction for the first language model to generate prosody data associated with the first natural language data based on the first input data and the context data.

13. A computing system comprising:
at least one processor; and
at least one memory including instructions that, when executed by the at least one processor, cause the computing system to:
receive first input data corresponding to a user input;
determine first prompt data including the first input data, wherein the first prompt data represents a first request for a first language model to determine an output responsive to the user input;
process, using the first language model, the first prompt data to generate first natural language data responsive to the user input;
process, using the first language model, the first prompt data to generate first prosody data representing at least a first voice characteristic;
use the first natural language data and the first prosody data to generate first output audio data representing first synthetic speech corresponding to the at least first voice characteristic; and
cause presentation of the first output audio data.

14. The computing system of claim 13, wherein:
the instructions that cause the computing system to process the first prompt data to generate the first natural language data comprise further instructions that, when executed by the at least one processor, further cause the computing system to process, using a first set of layers of the first language model, the first prompt data, wherein the first set of layers are configured for natural language generation; and
the instructions that cause the computing system to process the first prompt data to generate the first prosody data comprise further instructions that, when executed by the at least one processor, further cause the computing system to process, using a second set of layers of the first language model, the first prompt data, wherein the second set of layers are configured for prosody prediction.

15. The computing system of claim 14, wherein the instructions that cause the computing system to process, using the second set of layers of the first language model, the first prompt data comprise further instructions that, when executed by the at least one processor, further cause the computing system to:
receive, from a first layer of the first set of layers and at a second layer of the second set of layers, first embedding data representing the first prompt data, wherein the first prosody data is generated based at least in part by processing the first embedding data.

16. The computing system of claim 14, wherein the instructions that cause the computing system to process, using the first set of layers of the first language model, the first prompt data comprise further instructions that, when executed by the at least one processor, further cause the computing system to:
receive, from a first layer of the second set of layers and at a second layer of the first set of layers, first embedding data representing the first prompt data, and
process, by the first set of layers, the first prompt data and the first embedding data to generate the first natural language data.

17. The computing system of claim 15, wherein the at least one memory further comprises instructions that, when executed by the at least one processor, further cause the computing system to:
process, by the second layer of the second set of layers, the first prompt data and the first embedding data to generate second embedding data representing the first prompt data and the first embedding data; and
process the second embedding data using a third layer of the second set of layers to generate third embedding data representing the first prompt data, wherein the first prosody data is generated based at least in part on the third embedding data.

18. The computing system of claim 13, wherein the first prosody data corresponds to a spectrogram, and the instructions that cause the computing system to generate the first output audio data comprise further instructions that, when executed by the at least one processor, further cause the computing system to:
process, using a vocoder, the spectrogram.

19. The computing system of claim 13, wherein the first prosody data represents a natural language description of the at least first voice characteristic.

20. The computing system of claim 13, wherein the at least one memory further comprises instructions that, when executed by the at least one processor, further cause the computing system to:
receive context data associated with the user input, wherein the first prompt data represents a further instruction for the first language model to generate prosody data associated with the first natural language data based on the first input data and the context data.
